(19) United States
(12) Patent Application Publication
(10) Pub. No.: US 2025/0356558 A1
(43) Pub. Date: Nov. 20, 2025

(54) Computing Systems and Methods for Generating Media Content Using a Multi-Agent Architecture

(71) Applicant: Procore Technologies, Inc., Carpinteria, CA (US)

(72) Inventors: Siddhartha Chatterjee, Austin, TX (US); Matt Man, Thornhill (CA); Mohammad Mostafa Soltani, Toronto (CA); Farid Mirahadi, North York (CA)

(21) Appl. No.: 19/213,541

(22) Filed: May 20, 2025

Related U.S. Application Data
(60) Provisional application No. 63/649,813, filed on May 20, 2024.

(51) Int. Cl. G06T 11/60

(52) U.S. Cl. CPC G06T 11/60

(57) ABSTRACT

A computing platform configured to perform functionality that involves (i) receiving an indication of a request for media content related to a given construction project, (ii) utilizing a planner agent to generate a sequence of tasks to be performed by other agents to generate the requested media content, (iii) utilizing a knowledge agent to perform a first subset of the sequence of tasks to obtain a set of project data for use in generating the requested media content, (iv) utilizing a production agent to perform a second subset of the sequence of tasks to generate the requested media content, and (v) causing the generated media content to be presented via a client device.

### CROSS-REFERENCE TO RELATED APPLICATIONS

This application claims priority under U.S.C. § 119 (e) to U.S. Provisional Application No. 63/649,813 filed on May 20, 2024 and titled “Computer Systems and Methods for Using Artificial Intelligence to Generate Media Content,” the contents of which are incorporated by reference herein in their entirety.

### BACKGROUND

Increasingly, parties involved in construction projects are beginning to use software applications to manage those construction projects. One example of such a software application is the software-as-a-service (SaaS) application for construction management offered by Procore Technologies, Inc. (“Procore”), who is the current applicant. Using construction management software applications such as these, parties can create a digital representation of a given construction project that is to be managed and then create, store, view, and/or interact with various types of digital project data associated with the given construction project. Such digital project data may include specifications, drawings, building information model (BIM) files, requests for information (RFIs), punch lists (e.g., which list work that has not yet been completed or has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project), directories, invoices, timesheets, meeting minutes, sensor data, and daily logs (e.g., which record information about each day work is done at a work site of the construction project), among many other examples of project data that may be stored for a construction project.

### SUMMARY

Disclosed herein is new software-based artificial intelligence (AI) architecture that utilizes AI agents to synthesize construction project data into automatically generated and easily consumable media content, based on a user request.

In one aspect, the disclosed technology may take the form of a method that involves (i) receiving an indication of a request for media content related to a given construction project, (ii) utilizing a planner agent to generate a sequence of tasks to be performed by other agents to generate the requested media content, (iii) utilizing a knowledge agent to perform a first subset of the sequence of tasks to obtain a set of project data for use in generating the requested media content, (iv) utilizing a production agent to perform a second subset of the sequence of tasks to generate the requested media content, and (v) causing the generated media content to be presented via a client device.

In some examples, the method may further involve (vi) utilizing a question answering (QA) agent to perform a third subset of the sequence of tasks to generate, for use in generating the requested media content, a set of response information based on the set of project data, (vii) utilizing a visual agent to perform a fourth subset of the sequence of tasks to generate, for use in generating the requested media content, visual features and a corresponding script based on the set of response information, and (viii) utilizing a speech agent to perform a fifth subset of the sequence of tasks to generate, for use in generating the requested media content, audio features based on the visual features and the corresponding script. And in such examples, the functionality of utilizing the production agent to generate the requested media content may involve utilizing the production agent to generate the requested media content based on (a) the visual features and the corresponding script and (b) the audio features.

Further, in some examples, the functionality of utilizing the QA agent to generate the set of response information may involve (a) performing an analysis of the set of project data and (b) generating the set of response information based on the analysis of the set of project data. And in such examples, the set of response information may include at least one of (1) an answer to a question included in the request for media content, (2) an identification of an issue identified for the given construction project, (3) an identification of a proposed solution to an issue identified for the given construction project, or (4) a status of the given construction project.

Further yet, in some examples, the functionality of utilizing the visual agent to generate the visual features and corresponding script may involve (a) performing an analysis of at least one of (1) the set of project data or (2) the set of response information, and (b) generating the visual features and the corresponding script based on the analysis of the at least one of (1) the set of project data or (2) the set of response information. And in such examples, the visual features may include at least one of a video, an image, a document, or a slide, and the corresponding script may include a message to be narrated within the requested media content.

Further yet, in some examples, the functionality of utilizing the speech agent to generate the audio features may involve (a) performing an analysis of at least one of (1) the visual features or (2) the corresponding script, and (b) generating the audio features based on the analysis of the at least one of (1) the visual features or (2) the corresponding script. And in such examples, the audio features may include at least one of a text-to-speech rendition of a message included in the corresponding script, a text-to-speech rendition of one or more textual elements of the visual features, or sound effects corresponding to the visual features.

Further yet, in some examples, the method may further involve (ix) utilizing a quality control agent to validate at least one of (a) the sequence of tasks generated by the planner agent, (b) the set of project data obtained by the knowledge agent, (c) the set of response information generated by the QA agent, (d) the visual features generated by the visual agent, (e) the corresponding script generated by the visual agent, or (f) the audio features generated by the speech agent.

Further yet, in some examples, the various agents may be configured to utilize respective instances of a generative AI model. As one example, the planner agent may be configured to utilize a respective instance of a generative AI model to generate the sequence of tasks. As another example, the knowledge agent may be configured to utilize a respective instance of a generative AI model to obtain the set of project data. As yet another example, the QA agent may be configured to utilize a respective instance of a generative AI model to generate the set of response information. As yet another example, the visual agent may be configured to utilize a respective instance of a generative AI model to generate the visual features and the corresponding script. As yet another example, the speech agent may be configured to utilize a respective instance of a generative AI model to generate the audio features. As yet another example, the production agent may be configured to utilize a respective instance of a generative AI model to generate the requested media content.

Further yet, in some examples, each agent of the planner agent, the knowledge agent, the QA agent, the visual agent, the speech agent, and the production agent may include a respective system prompt that defines functionality of the agent.

Further yet, in some examples, the functionality of utilizing the knowledge agent to obtain the set of project data may involve utilizing the knowledge agent to analyze source project data stored for one or more construction projects to determine the set of project data.

Further yet, in some examples, the source project data may be stored as a knowledge graph having nodes and edges.

Further yet, in some examples, the generated media content may include a generative video with corresponding generative audio that are each generated based on the obtained project data.

In another aspect, the disclosed technology may take the form of a computing platform comprising at least one processor, at least one non-transitory computer-readable medium, and program instructions stored on the at least one non-transitory computer-readable medium that are executable by the at least one processor such that the computing platform is configured to carry out the functions of the aforementioned method.

In yet another aspect, the disclosed technology may take the form of a non-transitory computer-readable medium comprising program instructions stored thereon that are executable to cause a computing platform to carry out the functions of the aforementioned method.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### BRIEF DESCRIPTION OF THE DRAWINGS

FIG. 1 depicts an example network configuration in which example embodiments may be implemented, in line with the present disclosure.

FIG. 2 depicts an example software pipeline illustrating example functional components that may be utilized to synthesize construction project data into automatically generated media content, in line with the present disclosure.

FIG. 3 depicts an example flow chart to illustrate example functionality that may be carried out to generate requested media content, in line with the present disclosure.

FIG. 4 is a simplified block diagram that illustrates some structural components of an example computing platform that may be configured to carry out any of the various functions disclosed herein, in line with the present disclosure.

FIG. 5 is a simplified block diagram that illustrates some structural components of an example client device that may be configured to carry out any of the various functions disclosed herein, in line with the present disclosure.

Features, aspects, and advantages of the presently disclosed technology may be better understood with regard to the following description, appended claims, and accompanying drawings, as listed below. The drawings are for the purpose of illustrating example embodiments, but those of ordinary skill in the art will understand that the technology disclosed herein is not limited to the arrangements and/or instrumentality shown in the drawings.

### DETAILED DESCRIPTION

The following disclosure refers to the accompanying figures and several examples. A person of ordinary skill in the art will understand that such references are for the purpose of explanation only and are therefore not meant to be limiting. Part or all of the disclosed systems, devices, and methods may be rearranged, combined, added to, and/or removed in a variety of manners, each of which is contemplated herein.

Construction management today is often performed through the use of software applications, such as the construction management software application provided by Procore Technologies, Inc.® (“Procore,” which is the applicant of the present disclosure). These software applications generally provide users the ability to create, store, view, and/or interact with various types of data related to a construction project, such as specifications, drawings, building information model (BIM) files, requests for information (RFIs), punch lists (e.g., which list work that has not yet been completed or that has been completed incorrectly), risk management plans, safety plans, work breakdown structures, change orders, inspection documents (e.g., which record information about the results of inspections), construction submittals (e.g., mock-ups or other documents that contractors create to depict proposed plans), construction site observation reports, project management records (e.g., project schedules and project budgets), third-party records (e.g., applicable zoning restrictions, real-estate title records and purchase records, records of public hearings pertinent to the given construction project, etc.), directories, invoices, timesheets, meeting minutes, sensor data, and daily logs (e.g., which record information about each day work is done at a work site of the construction project), among many other examples of project data that may be stored for a construction project.

In practice, these construction management software applications may take various forms. As one possible implementation, a construction management software application may include both front-end client software running on client devices that are accessible to individuals associated with construction projects (e.g., contractors, project managers, architects, engineers, designers, etc.) and back-end software running on a back-end platform (sometimes referred to as a “cloud” platform) that interacts with and/or drives the front-end software, and which may be operated (either directly or indirectly) by the provider of the front-end client software. This form of a software application may be referred to as a client-server application or a software-as-a-service (SaaS) application, among other possibilities. As another possible implementation, a construction management software application may include front-end client software that runs on client devices without interaction with a back-end platform. These software applications may take other forms as well.

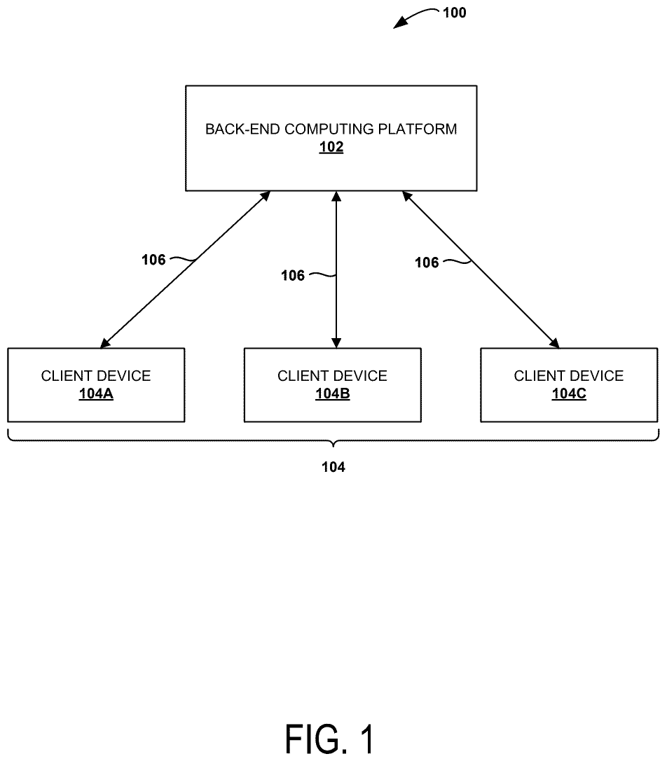

Turning now to the figures, FIG. 1 depicts an example network environment 100 in which a construction management software application may be implemented. As shown in FIG. 1, the network environment 100 includes a back-end computing platform 102 that may be communicatively coupled to one or more client devices 104, which include the client device 104A, the client device 104B, and the client device 104C. Although the client devices 104 are depicted by three devices as shown for the sake of simplicity in illustration, it should be understood that the client devices 104 may represent more or less than three devices without departing from the spirit and scope of this disclosure.

Broadly speaking, the back-end computing platform 102 may comprise one or more computing systems that have been provisioned with back-end software for a construction management software application, which may include program code for carrying out one or more of the platform-side functions disclosed herein. The one or more computing systems of the back-end computing platform 102 may collectively comprise some set of physical computing resources (e.g., one or more processors, data storage systems, communication interfaces, etc.), which may take various forms and be arranged in various manners.

For instance, as one possibility, the back-end computing platform 102 may comprise computing infrastructure of a public, private, and/or hybrid cloud (e.g., computing and/or storage clusters) that has been provisioned with back-end software for the construction management software application. In this respect, the entity that owns and operates the back-end computing platform 102 may supply its own cloud infrastructure or obtain the cloud infrastructure from a third-party provider of “on demand” computing resources, such as Amazon Web Services (AWS) or the like. As another possibility, the back-end computing platform 102 may comprise one or more dedicated servers that have been provisioned with back-end software for the construction management software application.

Further, in practice, the back-end software installed at the back-end computing platform 102 may be implemented using any of various software architecture styles, examples of which may include a microservices architecture, a service-oriented architecture, and/or a serverless architecture, among other possibilities, as well as any of various deployment patterns, examples of which may include a container-based deployment pattern, a virtual-machine-based deployment pattern, and/or a Lambda-function-based deployment pattern, among other possibilities.

Further yet, although not shown in FIG. 1, the back-end software installed at the back-end computing platform 102 may interact with a data storage layer of the back-end computing platform 102, which may comprise data stores of various different forms, examples of which may include relational databases (e.g., Online Transactional Processing (OLTP) databases), NoSQL databases (e.g., columnar databases, document databases, key-value databases, graph databases, etc.), file-based data stores (e.g., Hadoop Distributed File System), object-based data stores (e.g., Amazon S3), data warehouses (which could be based on one or more of the foregoing types of data stores), data lakes (which could be based on one or more of the foregoing types of data stores), message queues, or streaming event queues, among other possibilities.

The back-end computing platform 102 may comprise various other components and take various other forms as well.

In turn, the client devices 104 may each be any computing device that is capable of running front-end software of the construction management software application, which may include program code for carrying out the client-side functions disclosed herein. In this respect, the client devices 104 may each include hardware components such as one or more processors, computer-readable mediums, communication interfaces, and input/output (I/O) components (or interfaces for connecting thereto), among others, as well as software components that facilitate the client device's ability to run the front-end software (e.g., operating system software, web browser software, etc.). As representative examples, the client devices 104 may each take the form of a desktop computer, a spatial computer, a laptop, a netbook, a tablet, a smartphone, and/or a personal digital assistant (PDA), among other possibilities.

As further depicted in FIG. 1, the back-end computing platform 102 is configured to interact with the client devices 104 over respective communication paths 106. In this respect, each of the communication paths 106 between the back-end computing platform 102 and one of the client devices 104 may generally comprise one or more communication networks and/or communications links, which may take any of various forms. For instance, each of the respective communication paths 106 with the back-end computing platform 102 may include any one or more of point-to-point links, Personal Area Networks (PANs), Local-Area Networks (LANs), Wide-Area Networks (WANs) such as the Internet or cellular networks, and/or cloud networks, among other possibilities. Further, the communication networks and/or links that make up each of the respective communication paths 106 with the back-end computing platform 102 may be wireless, wired, or some combination thereof, and may carry data according to any of various different communication protocols. Further yet, communications over each of the respective communication paths 106 could be carried out via an Application Programming Interface (API), among other possibilities. Still further, although not shown, the respective communication paths 106 between the client devices 104 and the back-end computing platform 102 may also include one or more intermediate systems. For example, it is possible that the back-end computing platform 102 may communicate with a given client device 104 via one or more intermediary systems, such as a host server (not shown). Many other environments are also possible.

Although not shown in FIG. 1, the back-end computing platform 102 may also be configured to receive data, such as data related to a construction project, from one or more external data sources, such as an external database and/or another back-end computing platform or platforms. Such data source—and the data output by such data sources—may take various forms.

It should be understood that the network environment 100 depicted in FIG. 1 is one example of a network environment in which a construction management software application may be implemented. Numerous other arrangements are possible and contemplated herein. For instance, other network configurations may include additional components not pictured and/or more or fewer of the pictured components.

In a construction management software application such as the one described above, users are typically presented with a wide range of different information related to a construction project. This can provide various advantages, as many disparate types of information can be stored within the construction management software application and analyzed for future use, but it can also have drawbacks. For instance, when a user of a construction management software application wishes to answer a question or make a decision about a construction project, the user may have to gather, review, and digest a large amount of different information about the construction project that is available through the construction management software application, which can be time consuming and inefficient, and may lead to errors.

Further, formatting information about a construction project in a presentable way can also be difficult. This can be problematic in situations where a user of a construction management software application wishes to prepare and present media content for use in construction management. Given the wide range of different information that is stored for construction projects, the task of organizing different types of information and synthesizing it into a presentable format can be a time consuming and inefficient endeavor. Further, any errors in media content that is created independently of the project data and presented for use in construction management may cause further inefficiencies in construction projects. For instance, a schedule that has been created or adjusted based on an erroneous media content presentation may lead to scheduling delays, among other inefficiencies.

To address these and other disadvantages, disclosed herein is software technology that utilizes artificial intelligence (AI) to synthesize construction project data into automatically generated and easily consumable media content, based on a user request. The automatically generated media content may take various forms, such as a document, image and/or video, among other forms, and may include various types of information relevant to a user request, such as answers to questions asked in the user request, summaries of relevant project information, portions of relevant drawings, photos, or other types of project data, and/or presentations of solutions to identified risks, among various other types of information. Further, the automatically generated media content may include audio content, such as a narration of the information included in the automatically generated media content, among other types of audio content. The automatically generated media content may take other forms as well, and is described in greater detail below. Further, although the media content is described as being automatically generated based on user requests, in some implementations, the media content may be automatically generated based on other requests as well, such as requests from other entities, computing systems, generative AI models, or the like.

The disclosed technology may take the form of a software pipeline for synthesizing construction project data into automatically generated media content. At a high level, the disclosed software pipeline may comprise a sequence of functional components that collectively operate to synthesize construction project data into automatically generated media content responsive to an input prompt, wherein the media content is generated based on source project data, which may include any of the types of project that may be stored for one or more construction projects previously described, or otherwise accessible by the software pipeline, such as source project data stored by a third-party computing system or the like.

The disclosed technology improves upon existing technology for generating media content for use in construction management in various ways. Because the disclosed technology uses source project data to generate media content for a construction project, the generated media content is highly accurate and relevant, allowing users of the disclosed technology to rely on the generated media content for making decisions regarding the construction project. Further, because users are able to automate the generation of media content, user efficiency is increased, allowing users to turn to other construction management tasks, among other things.

The disclosed technology improves upon existing technology for generating media content for use in construction management in other ways as well.

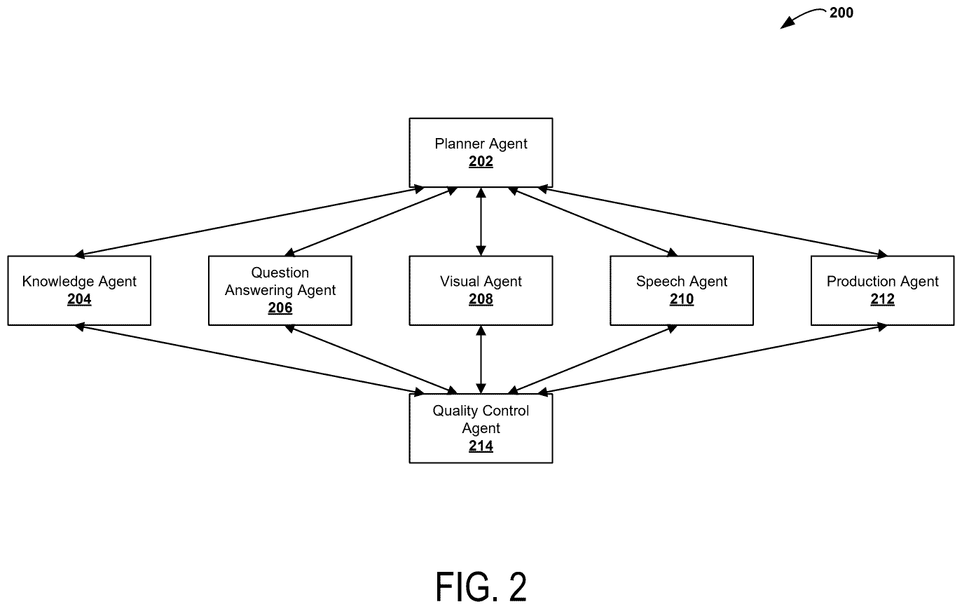

Turning now to FIG. 2, an example software pipeline 200 is depicted to illustrate example functional components that may be included in the disclosed software pipeline for synthesizing construction project data into automatically generated media content. In practice, the example software pipeline 200 may be encoded in the form of program instructions that are executable by one or more processors of a computing platform, and for purposes of illustration, the example software pipeline 200 is described as being installed on and executed by the back-end computing platform 102 of FIG. 1, but it should be understood that the example software pipeline 200 may be installed on and executed by any one or more computing platforms that are capable of performing the example operations of the example software pipeline 200. Further, it should be understood that the example software pipeline 200 is merely described in this manner for the sake of clarity and explanation and that the example functional components may be implemented in various other manners, including the possibility that functional components may be added, removed, rearranged into different orders, combined into fewer functional components, and/or separated into additional functional components depending upon the particular embodiment.

As shown in FIG. 2, the example software pipeline 200 comprises seven different types of agents that may be utilized to synthesize construction project data into automatically generated media content, which are referred to herein as (i) a “planner agent” 202, (ii) a “knowledge agent” 204, (iii) a “question answering (QA) agent” 206, (iv) a “visual agent” 208, (v) a “speech agent” 210, (vi) a “production agent” 212, and (vii) a “quality control agent” 214. Each of these disclosed agents may take various forms. In practice, the example software pipeline 200 may include more or fewer agents than those described.

At a high level, each of the agents 202-214 may generally take the form of a software component that has access to an instance of any of various types of generative AI models (e.g., transformer-based models such as large language and/or large multimodal models, diffusion models, generational adversarial networks, etc.), which may themselves comprise underlying machine-learning models such as neural networks. Further, in some implementations, the generative AI model may comprise a pre-trained generative AI model, a pre-trained generative AI model that is fine-tuned using domain-specific training data, or a generative AI model that is trained in the first instance using domain-specific data, among other possibilities. In this respect, the fine-tuning and/or training of the generative AI model may involve any of various types of machine-learning techniques, including but not limited to supervised, self-supervised, and/or unsupervised learning techniques. Further yet, in some implementations, the generative AI model may comprise a combination of multiple AI models (e.g., a generative AI model in combination with a rewards model or perhaps multiple types of generative AI models working in tandem), among other possibilities.

The generative AI models accessed by the agents 202-214 may be the same or different. As one example, each of the agents 202-214 may have access to the same instance of a generative AI model. As another example, each of the agents 202-214 may have access to a respective instance of a generative AI model. As yet another example, a first subset of the agents 202-214 may have access to an instance of a first generative AI model, and a second subset of the agents 202-214 may have access to an instance of a second generative AI model. Various other examples may also exist. Further, in some implementations, the generative AI model accessed by a given agent may be fine-tuned for the functionality that is to be performed by the given agent. Various other implementations may also exist.

Each of the agents 202-214 may also include a respective system prompt. The system prompt for each of the agents 202-214 may include various types of information for the agent, including a description the agent's role within the software pipeline 200, among other possibilities. The system prompts for the agents 202-214, as well as other aspects of the agents 202-214, are described in greater detail below.

Starting first with the planner agent 202, at a high level, the planner agent 202 may generally function to receive input prompts indicating requests for media content, e.g., relevant to construction management, and, for each request, (i) determine a sequence of tasks that are to be completed by the agents of the software pipeline 200 and (ii) coordinate with the agents of the software pipeline 200 in order to generate the requested media content.

In line with the discussion above, the planner agent 202 may include a system prompt, which may include various types of information. One possible type of information that may be included in the system prompt for the planner agent 202 may include a description of the planner agent's role within the software pipeline 200, which may be to receive input prompts indicating requests for media content, and, for each request: (i) determine a sequence of tasks that are to be completed by other agents within the software pipeline 200 and (ii) coordinate with those agents in order to generate the requested media content. The description of the planner agent's role may take various other forms as well.

Another possible type of information that may be included in the system prompt for the planner agent 202 may include a description of the other agents in the software pipeline 200. This may include information describing the roles of the other agents, whether any dependencies exist between the other agents (e.g., whether one agents' output is a required or otherwise expected input of another agent, etc.), and/or the respective format that the input prompts for each of the other agents is to take, among other possibilities. One example system prompt for the planner agent 202 may be as follows: “You are a construction management expert. Please provide a detailed step-by-step plan before answering any questions, including describing what other agents and tools you will need to use in order to provide the best answer.” Another example system prompt for the planner agent 202 may be as follows: “You are an expert planning agent tasked with first understanding the user's intent, then coordinating with the available tools and agents to design a valid workflow that produces the desired output.” Various other examples may also exist.

The system prompt for the planner agent 202 may include various other types of information as well.

In line with the discussion above, the planner agent 202 may be configured to receive one or more input prompts. For instance, a user of the construction management software application operating a client device 104 may input one or more input prompts to the client device 104, and the client device 104 may transmit the indication to the back-end computing platform 102 via the communication path 106 between the client device 104 and the back-end computing platform 102. The back-end computing platform 102 may then provide the indication to the planner agent 202. The planner agent 202 may receive input prompts in other ways as well, such as from other computing systems and/or agents, among other possibilities.

The input prompts received by the planner agent 202 may include various types of information. One possible type of information that may be included in an input prompt received by the planner agent 202 may include an indication of a user request for media content. The user request for the media content may take various forms. In some implementations, the user request may describe the media content to be generated, and in some implementations, may include instructions for generating the media content. In some implementation, the instructions for generating the media content may specify one or more tasks to be performed by agents of the software pipeline 200 for generating the media content, while in others, the instructions may not specify such tasks. Some example instructions may include (i) instructions showing examples of what the generated media content should look like, (ii) instructions defining the format that the generated media content should take, (iii) instructions defining a tone that the generated media content should take, (iv) instructions defining one or more constraints for the generated media content, such as a limited file size and/or a limited word count, among other possible constraints, and (v) instructions describing what language the generated media content should be in. The input prompt may comprise various other instructions for generating the media content as well. Further, in line with the discussion above, although the request for media content is described as being a user request, in some implementations, the request for media content may be from other entities as well, such as a request from another computing system, agent, or the like.

Another possible type of information that may be included in an input prompt received by the planner agent 202 may include an indication of source project data for use in generating the media content. In some implementations, the indication of source project data may include directions for obtaining the source project data, such as a pointer to where the source project data is stored, among other possible types of directions. Additionally and/or alternatively, in some implementations, the indication of source data may comprise the source project data itself. The source project data indicated in the input prompt may include project data for one or more construction projects, such as (i) one or more construction projects referenced in the input prompt (e.g., in the user request for media content or other information included in the input prompt), and possibly (ii) one or more other construction projects that may be similar to the one or more construction projects referenced in the input prompt.

In some implementations, the source project data may take the form of a knowledge graph (e.g., a semantic knowledge graph) that captures the source project data as well as various relationships within the source project data. For instance, the knowledge graph may comprise a plurality of nodes to represent the source project data, as well as edges between the nodes of the knowledge graph that represent relationships between the nodes. The source project data may take other forms as well.

Input prompts received by the planner agent 202 may include various other types of information as well. Further, in at least some implementations, the planner agent 202 may receive multiple input prompts. As one example, the planner agent 202 may receive a first input prompt including a first type of information, a second input prompt including a second type of information, and so forth. In this case, the planner agent 202 may perform its functionality based on all of the information included in the multiple input prompts. As another example, the planner agent 202 may receive a first input prompt, and then may additionally receive an updated second input prompt which may correct or expound upon the information included in the first input prompt. In this case, the planner agent 202 may perform its functionality based on the updated second input prompt. Various other examples may also exist.

An example input prompt for the planner agent 202 may be “Please prepare a PowerPoint presentation that shows and summarizes any conflicts between the plumbing design and the duct work on the first two floors of this construction project. Please organize the presentation by room. Also, if any conflicts exist, please propose three solutions to the conflicts, and explain the value of each solution.” As may be appreciated, the planner agent 202 may receive various other input prompts as well.

The planner agent's functionality may take any of various forms. Firstly, the planner agent's functionality may include receiving one or more input prompts, in line with the discussion above.

The planner agent's functionality may also include generating, based on the one or more received input prompts, a sequence of tasks that are to be performed by the agents of the software pipeline 200. To accomplish this, the planner agent 202 may provide input to the instance of the generative AI model accessible to the planner agent 202, such as the planner agent's system prompt and the one or more input prompts received by the planner agent 202, among other possible inputs. The planner agent 202 may then obtain, from the instance of the generative AI model, an output comprising the sequence of tasks.

The tasks included in the sequence of tasks may take various forms. For instance, each task of the sequence of tasks may include (i) an identification of which agent of the software pipeline 200 is to complete the task and (ii) instructions for the agent of the software pipeline 200 to complete the task. The tasks of the sequence of tasks may take other forms as well.

Further, in some implementations, the planner agent 202 may generate the entire sequence of tasks at once, while in other implementations, the planner agent 202 may generate a subset of tasks at first, and may generate subsequent tasks over time, e.g., as other tasks are completed by the agents of the software pipeline 200. The planner agent 202 may generate the sequence of tasks in other ways as well.

The planner agent's functionality may also include coordinating with the agents of the software pipeline 200 to complete the sequence of tasks. This coordination may take any of various forms, depending on the tasks that are to be completed and which agent of the software pipeline 200 is to complete each task.

For example, the planner agent 202 may coordinate with the knowledge agent 204 to perform various tasks, such as (i) analyzing project data to determine a set of project data for use in generating the requested media content, (ii) obtaining the set of project data, (iii) pre-processing the set of project data, and (iv) providing the set of project data to one or more of the agents 206-214, among other possible tasks. To coordinate with the knowledge agent 204 to perform one or more of these tasks, the planner agent 202 may send one or more input prompts to the knowledge agent 204 that includes instructions for completing the tasks. The planner agent 202 may coordinate with the knowledge agent 204 in other ways as well.

Further, the planner agent 202 may coordinate with the QA agent 206 to perform various tasks, such as generating a set of response information for use in generating requested media content, among other possible tasks. To coordinate with the QA agent 206 to generate the set of response information, among other possible tasks, the planner agent 202 may send one or more input prompts to the QA agent 206 that includes instructions for completing the tasks. The planner agent 202 may coordinate with the QA agent 206 in other ways as well.

Further yet, the planner agent 202 may coordinate with the visual agent 208 to perform various tasks, such as generating visual features and a corresponding script for use in generating requested media content, among other possible tasks. To coordinate with the visual agent 208 to perform one or more of these tasks, the planner agent 202 may send one or more input prompts to the visual agent 208 that includes instructions for completing the tasks. The planner agent 202 may coordinate with the visual agent 208 in other ways as well.

Further yet, the planner agent 202 may coordinate with the speech agent 210 to perform various tasks, such as generating audio features for use in generating requested media content, among other possible tasks. To coordinate with the speech agent 210 to generate audio features, among other possible tasks, the planner agent 202 may send one or more input prompts to the speech agent 210 that includes instructions for completing the tasks. In connection with coordinating with the speech agent 210, the planner agent 202 may be configured to determine what language the audio features are to be in, as well as what accents the speech agent 210 is to use for the audio features, among other possibilities. To accomplish this, the planner agent 202 may determine an intended audience for the requested media content, e.g., based on information included in the one or more input prompts received by the planner agent 202. The planner agent 202 may coordinate with the speech agent 210 in other ways as well.

Further yet, the planner agent 202 may coordinate with the production agent 212 to perform various tasks, such as generating requested media content, among other possible tasks. To coordinate with the production agent 212 to generate requested media content, among other possible tasks, the planner agent 202 may send one or more input prompts to the production agent 212 that includes instructions for completing the tasks. The planner agent 202 may coordinate with the production agent 212 in other ways as well.

Further yet, the planner agent 202 may coordinate with the quality control agent 214 to perform various tasks, such as validating the outputs of the agents of the software pipeline 200, among other possible tasks. To coordinate with the quality control agent 214 to perform one or more of these tasks, the planner agent 202 may send one or more input prompts to the quality control agent 214 that includes instructions for completing the tasks. The planner agent 202 may coordinate with the quality control agent 214 in other ways as well.

The planner agent 202 may coordinate with each of the agents of the software pipeline 200 at various times. As one possibility, the planner agent 202 may coordinate with the agents of the software pipeline 200 in a sequential manner. For example, the planner agent 202 may first coordinate with the knowledge agent 204 until the knowledge agent 204 has completed one or more tasks, after which the planner agent 202 may coordinate with the quality control agent 214 to validate the output(s) of the knowledge agent 204. If the quality control agent 214 determines that one or more of the output(s) of the knowledge agent 204 need to be revised, then the planner agent 202 may again coordinate with the knowledge agent 204 to complete the revisions. Once the outputs of the knowledge agent 204 have been validated, the planner agent 202 may then coordinate with the QA agent 206 until the QA agent 206 has completed one or more tasks. The planner agent 202 may then coordinate with the quality control agent 214 to validate the output(s) of the QA agent 206. This pattern may continue for the other agents of the software pipeline 200. Further, in some implementations, the planner agent 202 may go back and transmit updated input prompts to one or more agents, causing the one or more agents to redo some or all of their functionality, e.g., based on additional information included in the output of other (e.g., downstream) agents. This may cause the agents of the software pipeline 200 to generate various iterations of their outputs, until a satisfactory set of outputs from the agents are produced. Other examples of sequential coordination with the agents of the software pipeline 200 may also exist.

As another possibility, the planner agent 202 may coordinate with multiple agents of the software pipeline 200 in a parallel manner. For instance, the planner agent 202 may transmit input prompts to several of the agents of the software pipeline 200 and coordinate with those agents to complete their respective tasks in parallel. In such implementations, the planner agent 202 may transmit updated input prompts to the agents as tasks are complete. This may cause certain agents to redo some or all of their functionality, e.g., based on the additional information included in the outputs of other agents. In this manner, the agents of the software pipeline 200 may generate various iterations of their outputs until a satisfactory set of outputs from the agents are produced.

The planner agent 202 may coordinate with the agents of the software pipeline 200 at other times and in various other ways as well. In some implementations, the planner agent 202 may utilize the instance of the generative AI model accessible to the planner agent 202 to coordinate with the agents of the software pipeline 200, e.g., to determine what types of input prompts to transmit to the agents, among other examples.

The planner agent's functionality may take other forms as well.

Turning now to the knowledge agent 204, at a high level, the knowledge agent 204 may generally function to determine a set of project data for use in generating requested media content.

In line with the discussion above, the knowledge agent 204 may include a system prompt, which may include various types of information. One possible type of information that may be included in the system prompt for the knowledge agent 204 may include a description of the knowledge agent's role within the software pipeline 200, which may be to determine a set of project data for use in generating requested media content. Another possible type of information that may be included in the system prompt for the knowledge agent 204 may include a description of what information the knowledge agent 204 has access to. One example system prompt for the knowledge agent 204 may be as follows: “You are a knowledgeable construction management expert that knows all of the project data based on our data schema and where the information lies in our databases and file systems.” Various other examples may also exist.

The system prompt for the knowledge agent 204 may include various other types of information as well.

In line with the discussion above, the knowledge agent 204 may be configured to receive one or more input prompts from the planner agent 202, each of which may include various types of information.

One possible type of information that may be included in an input prompt that the knowledge agent 204 receives from the planner agent 202 may include instructions to complete one or more tasks, such as (i) instructions to analyze source project data to determine a set of project data for use in generating requested media content, (ii) instructions to obtain the set of project data, (iii) instructions to pre-process the set of project data, (iv) instructions to determine industry best practices based at least on the set of project data, and (v) instructions to provide the set of project data and determined industry best practices to one or more agents of the software pipeline 200, among other possible tasks. The instructions may include details about the requested media content, such as (i) a time associated with the requested media content, (ii) a location associated with the requested media content, (iii) schedule activities associated with the requested media content, (iv) cost codes associated with the requested media content, (v) quality references associated with the requested media content, (vi) safety standards associated with the requested media content, (vii) identified statuses (e.g., whether a task is on time or delayed) associated with the requested media content, (viii) identified completion statuses (e.g., drafted/rejected/approved) associated with the requested media content, and/or (ix) information regarding entities that may be relevant to the requested media content, among other possible details.

The instructions may also specify how to complete each task. As one example, instructions to analyze source project data to determine a set of project data may specify the information to include in the set of project data (e.g., by specifying that project data of one or more types are to be included in the set of project data, such as RFIs, submittals, and/or drawings, among other possible types of project data). As another example, instructions to provide the set of project data to one or more agents of the software pipeline 200 may specify which agents of the software pipeline 200 the set of project data is to be provided to (e.g., directly to the planner agent 202 for distribution to other agents of the software pipeline 200, and/or directly to one or more other agents of the software pipeline 200).

The instructions may also specify a format that output of the knowledge agent 204 should take. For instance, the instructions may specify that the set of project data provided by the knowledge agent 204 should be structured as one or more JSON objects. The instructions may specify other formats as well.

The instructions may take other forms as well.

Another possible type of information that may be included in an input prompt received from the planner agent 202 may include an indication of source project data for use in generating the media content. In some implementations, the indication of source project data may include directions for obtaining the source project data, such as a pointer to where the source project data is stored, among other possible types of directions. Additionally and/or alternatively, in some implementations, the indication of source project data may comprise the source project data itself. The source project data indicated in the input prompt may include project data for one or more construction projects, such as (i) one or more construction projects referenced in the input prompt received by the planner agent 202 (e.g., in the user request for media content or other information in the input prompt), and possibly (ii) one or more other construction projects that may be similar to the one or more construction projects referenced in the input prompt. In some implementations, the source project data may take the form of a knowledge graph (e.g., a semantic knowledge graph), in line with the previous discussion.

Input prompts received by the knowledge agent 204 may include various other types of information as well.

One example input prompt for the knowledge agent 204 may be “find the RFIs, photos, and drawings between the architectural plans, the plumbing drawings, the mechanical drawings, and any detail shop drawings that are related to a given location, including both top down and side/elevation drawings.” Another example input prompt for the knowledge agent 204, which the knowledge agent 204 may receive after receiving the first example input prompt, may be “find any related BIM objects.” As may be appreciated, the knowledge agent 204 may receive various other input prompts, e.g., depending on the request for media content.

The knowledge agent's functionality may take any of various forms. Firstly, the knowledge agent's functionality may include receiving one or more input prompts from the planner agent 202, as described above.

The knowledge agent's functionality may also include completing tasks based on instructions included in the one or more input prompts received from the planner agent 202. This functionality may take various forms, depending on the one or more input prompts received from the planner agent 202.

In line with the above discussion, one task that the knowledge agent 204 may complete may be to analyze source project data to determine a set of project data for use in generating requested media content. If the instructions included in the one or more input prompts received from the planner agent 202 specify the information to include in the set of project data (e.g., by specifying one or more types of information that are to be included in the set of project data), then the knowledge agent 204 may analyze the source project data to identify the specified information to include in the set of project data. However, if the instructions included in the one or more input prompts received from the planner agent 202 do not specify the information to include in the set of project data, then the knowledge agent 204 may analyze the source project data to identify information to include in the set of project data that is relevant to the requested media content.

The knowledge agent 204 may determine which information is relevant to the requested media content in various ways. In implementations where the source project data takes the form of a knowledge graph (e.g., a semantic knowledge graph), the knowledge agent 204 may analyze the knowledge graph to determine which information is relevant to the requested media content. For instance, the knowledge agent 204 may navigate the nodes and edges of the knowledge graph to (i) identify project data that is relevant to one or more of the details about the requested media content that were included in the instructions included in the one or more input prompts received from the planner agent 202 and then (ii) include the identified project data in the set of project data.

In some implementations, the functionality of determining the set of project data may further involve determining, based on the analysis of the source project data, that additional information is needed beyond what is included in the source project data. For instance, the knowledge agent 204 may determine, based on the analysis of the source project data, that additional information needed for generating the requested media content is unavailable. Based on this determination, the knowledge agent 204 may then function to (i) identify a source where the additional information may be obtained, as well as to (ii) include the additional information in the set of project data, e.g., once obtained from the source. The source where the additional information may be obtained may take various forms, such as an industry expert (either within the entity where the knowledge agent 204 is implemented or remote to the entity) and/or an expert agent or the like, among other possible examples. The knowledge agent 204 may identify the source in various ways, such as based on information included in one or more input prompts received from the planner agent 202, among other possible examples. The knowledge agent 204 may accomplish the functionality for determining that additional information is needed, and then identifying the source where the additional information may be obtained, in various other ways as well.

The functionality of the knowledge agent 204 to determine the set of project data may be accomplished through the use of the instance of the generative AI model accessible to the knowledge agent 204. For instance, the knowledge agent 204 may provide input to the instance of the generative AI model, such as the knowledge agent's system prompt, the instructions to complete the one or more tasks, and/or the indication of the source project data, among other possible inputs. The knowledge agent may then obtain, from the instance of the generative AI model, an output indicating the set of project data. The knowledge agent 204 may analyze the source project data to determine the set of project data in other ways as well.

In line with the above discussion, another task that the knowledge agent 204 may complete may be to obtain the set of project data. In implementations where the source project data is included in an input prompt from the planner agent 202, the knowledge agent 204 may obtain the set of project data, e.g., from the source project data included in the input prompt from the planner agent 202 and/or from the identified source of the additional information. In implementations where directions for obtaining the source project data is included in an input prompt from the planner agent 202, the knowledge agent 204 may obtain the set of project data from wherever the source project data is stored, based on the directions included in the input prompt from the planner agent 202 (e.g., from storage of the back-end computing platform 102, from external storage, etc.). In line with the discussion above, the knowledge agent 204 may utilize the instance of the generative AI model accessible to the knowledge agent 204 to obtain the set of project data.

In line with the above discussion, yet another task that the knowledge agent 204 may complete may be to pre-process the set of project data. The knowledge agent 204 may pre-process the set of project data by performing one or more pre-processing operations on the set of project data (e.g., validation, cleansing, deduplication, filtering, aggregation, summarization, enrichment, restructuring, reformatting, translation, mapping, etc.) to prepare the set of project data for use by other agents of the software pipeline 200. Further, in some implementations, the set of project data may be pre-processed by another agent instead. Also, in some implementations, the set of project data may not need to be pre-processed.

In line with the above discussion, yet another task that the knowledge agent 204 may complete may be to determine industry best practices, e.g., such as industry best practices that are most relevant to a question or the like that is included in an input prompt received from the planner agent 202. The knowledge agent 204 may determine the industry best practices based on an evaluation of (i) information included in the input prompt received from the planner agent 202 (which the knowledge agent 204 may receive from the planner agent 202), and (ii) relevant information from the set of project data, such as (a) information available from one or more construction associations, (b) information describing means and method for construction of certain elements, and/or (c) information describing standard operating procedures for the entity or other construction organizations, among other possible types of information that may be included in the set of project data.

In some implementations, the knowledge agent 204 may utilize the knowledge agent's instance of the generative AI model to perform this evaluation. For instance, the knowledge agent 204 may provide input to the instance of the generative AI model accessible to the knowledge agent 204, such as information included in the input prompt received from the planner agent 202 and the set of project data, among other possible types of information, and then obtain, from the instance of the generative AI model, an output indicating the industry best practices. The knowledge agent 202 may determine the industry best practices in other ways as well.

In line with the above discussion, yet another task that the knowledge agent 204 may complete may be to provide the set of project data and the determined industry best practices to one or more of the agents of the software pipeline 200. To complete this task, the knowledge agent 204 may first determine which agent(s) to provide the set of project data and the determined industry best practices to. For instance, the knowledge agent 204 may provide input to the instance of the generative AI model accessible to the knowledge agent 204 (e.g., such as the inputs described above) and obtain, from the instance of the generative AI model, an output indicating which agent(s) the set of project data and the determined industry best practices are to be provided to. In line with the discussion above, this may include (i) an indication that the set of project data and the determined industry best practices are to be provided to the planner agent 202 for distribution to other agents of the software pipeline 200, and/or (ii) an indication that the set of project data and the determined industry best practices are to be provided directly to the other agents of the software pipeline 200.

Further, in some implementations, rather than providing the set of project data itself, the knowledge agent 204 may instead provide instructions for the planner agent 202 or other agents of the software pipeline 200 to obtain the set of project data, e.g., from wherever the source project data (and consequentially the set of project data) is stored. In such implementations, the knowledge agent 204 may not need to obtain and pre-process the set of project information. Instead, the knowledge agent 204 may simply determine the set of project data from the source project data and then provide instructions to other agents of the software pipeline 200 to obtain the set of project data from the source project data.

The knowledge agent 204 may complete other tasks as well, and the functionality that the knowledge agent 204 may perform may take other forms as well.

Turning now to the QA agent 206, at a high level, the QA agent 206 may generally function to generate a set of response information that may be used to generate the requested media content.

In line with the discussion above, the QA agent 206 may include a system prompt, which may include various types of information. One possible type of information that may be included in the system prompt for the QA agent 206 may include a description of the QA agent's role within the software pipeline 200, which may be to generate a set of response information that may be used to generate the requested media content. Another possible type of information that may be included in the system prompt for the QA agent 206 may include a description of what information the QA agent 206 has access to. One example system prompt for the QA agent 206 may be as follows: “You are a knowledgeable construction management expert familiar with modern construction methodologies and sequencing, and have access to various construction projects of the same type, as well as to benchmark data for the various construction projects.” Various other examples may also exist.

The system prompt for the QA agent 206 may include various other types of information as well.

In line with the previous discussion, the QA agent 206 may be configured to receive one or more input prompts from the planner agent 202, each of which may include various types of information.

One possible type of information that may be included in an input prompt received from the planner agent 202 may include a question or request included in the request for media content.

Another possible type of information that may be included in an input prompt received from the planner agent 202 may include instructions to complete one or more tasks, such as (i) instructions to generate a set of response information for use in generating requested media content, and/or (ii) instructions to provide the set of response information to one or more agents of the software pipeline 200, among other possible tasks.

The instructions to generate the set of response information may also specify what types of information are to be included in the set of response information, such as (i) a recitation and/or explanation of a question included in the request for media content, (ii) a breakdown of the question (e.g., an explanation of additional questions and/or considerations stemming from the question, such as the determined industry best practices, among other possibilities), (iii) an answer to the question, which may include answers to the additional questions stemming from the question, one or more suggested actions to take to resolve an issue, etc., and/or (iv) a status of a construction project indicated in the request for media content (e.g., a status of a timeline of the construction project, a status of an inventory of materials needed for the construction project, etc.), among other possible types of information that are to be included in the set of response information.

Another possible type of information that may be included in an input prompt received from the planner agent 202 may include an indication of the set of project data and the determined industry best practices provided by the knowledge agent 204. In some implementations, the indication of the set of project data may comprise the source project data itself. In other implementations, the indication of the set of project data may comprise directions for obtaining the set of project data, in line with the previous discussion. Further, in some implementations, the QA agent 206 may receive the indication of the set of project data and/or the determined industry best practices directly from the knowledge agent 204 instead of from the planner agent 202.

In implementations where the set of project data has not been pre-processed for use by the QA agent 206, the QA agent 206 may pre-process the set of project data.

Yet another possible type of information that may be included in an input prompt received from the planner agent 202 may include construction methodology information and sequencing information for use in generating the set of response information. For instance, the construction methodology information may include information regarding methods for effectively managing construction projects, and the sequencing information may include information regarding strategies for effectively sequencing tasks in a construction project. The construction methodology information and sequencing information may include other information as well.

In some implementations, the QA agent 206 may obtain the construction methodology information and sequencing information without such information being included in an input prompt received from the planner agent 202. For instance, the QA agent 206 may obtain the construction methodology information and sequencing information from storage (either internal to the back-end computing platform 102 or external to the back-end computing platform 102).

Some example input prompts for the QA agent 206 may be “Find any potential clashes between plumbing and mechanical designs from the drawings on the 3rd floor, near room 305, and list them out,” “for each of the items on the list, find the corresponding photos taken in that area,” “identify the schedule items that are associated with each of the items on the list,” “understand the impact of this clash to the schedule items and the potential delays,” and “provide at least two suggested options on how to remedy this design conflict.” As may be appreciated, the QA agent 206 may receive various other input prompts, e.g., depending on the request for media content.

The QA agent's functionality may take any of various forms. Firstly, the QA agent's functionality may include receiving one or more input prompts from the planner agent 202, as described above.

The QA agent's functionality may also include completing tasks based on instructions included in the one or more input prompts received from the planner agent 202. This functionality may take various forms, depending on the one or more input prompts received from the planner agent 202.

In line with the above discussion, one task that the QA agent 206 may complete may be to generate a set of response information for use in generating requested media content. The QA agent 206 may generate the set of response information based on an analysis of (i) construction methodologies and sequencing information obtained by the QA agent 206, (ii) the question and/or request included in the request for media content, (iii) the set of project data and determined industry best practices obtained by the QA agent 206 (e.g., directly from the knowledge agent 204 or from the planner agent 202), and (iv) any indication of the types of information to include in the set of response information that may be included in input prompts received from the planner agent 202. In line with the discussion above, the QA agent 206 may utilize the instance of the generative AI model accessible to the QA agent 206 to perform the analysis and generate the set of response information. For instance, the QA agent 206 may provide input to the instance of the generative AI model, such as the QA agent's system prompt, the construction methodologies and sequencing information, the question and/or request, the set of project data, the determined industry best practices, and/or any indication of the types of information to include in the set of response information, among other possible inputs. The QA agent 206 may then obtain, from the instance of the generative AI model, an output comprising the set of response information. The QA agent 206 may generate the set of response information in other ways as well.

In line with the above discussion, another task that the QA agent 206 may complete may be to provide the set of response information to one or more of the agents of the software pipeline 200. To complete this task, the QA agent 206 may first determine which agent(s) to provide the set of response information to. For instance, the QA agent 206 may provide input to the instance of the generative AI model accessible to the QA agent 206 (e.g., such as the inputs described above), and receive, as output from the generative AI model, an identification of which agent(s) the set of response information is to be provided to. In line with the discussion above, this may include (i) an indication that the set of response information is to be provided to the planner agent 202 for distribution to other agents of the software pipeline 200, and/or (ii) an indication that the set of response information is to be provided directly to the other agents of the software pipeline 200.

The QA agent 206 may complete other tasks as well, and the functionality that the QA agent 206 may perform may take other forms as well.

Turning now to the visual agent 208, at a high level, the visual agent 208 may generally function to generate visual features and a corresponding script for use in generating requested media content.

In line with the discussion above, the visual agent 208 may include a system prompt, which may include various types of information. One possible type of information that may be included in the system prompt for the visual agent 208 may include a description of the visual agent's role within the software pipeline 200, which may be to generate visual features and a corresponding script for use in generating the requested media content. One example system prompt for the visual agent 208 may be as follows: “You are a knowledgeable screen writer who can combine different types of media content and create a video script to answer a user question.” Various other examples may also exist.

The system prompt for the visual agent 208 may include various other types of information as well.

In line with the previous discussion, the visual agent 208 may be configured to receive one or more input prompts from the planner agent 202, which may include various types of information.

One possible type of information that may be included in an input prompt received from the planner agent 202 may include instructions to complete one or more tasks, such as (i) instructions to generate visual features and a corresponding script for use in generating requested media content, and/or (ii) instructions to provide the visual features and corresponding script to one or more agents of the software pipeline 200, among other possible tasks. The instructions to generate visual features and a corresponding script for use in generating requested media content may specify what types of visual features to generate, such as videos, animations, images, documents, slideshows, etc., as well as possibly annotations to the videos, images, slideshows, etc. (e.g., highlighted and/or circled portions of a video, image, slideshow, etc.), among other types of visual features. As one possible example, the instructions may specify that the requested media content should include, among other kinds of visual features, an animation of a character (e.g., a mascot associated with the entity operating the back-end computing platform 102, or some other character) that is animated to narrate one or more portions of the media content.

The instructions to generate visual features and a corresponding script for use in generating requested media content may also include specifications for the script. As one example, the instructions may specify that the script should include (i) a message to be narrated within the requested media content, (ii) instructions for how to include the generated visual features in the requested media content, or both. As another example, the instructions may specify a word limit of the script. Various other examples may also exist.

Another possible type of information that may be included in an input prompt received from the planner agent 202 may comprise an indication of the set of project data and the determined industry best practices provided by the knowledge agent 204. In some implementations, the indication of the set of project data may comprise the source project data itself. In other implementations, the indication of the set of project data may comprise directions for obtaining the set of project data, in line with the previous discussion. Further, in some implementations, the visual agent 208 may receive the indication of the set of project data and/or the determined industry best practices directly from the knowledge agent 204 instead of from the planner agent 202.

In implementations where the set of project data has not been pre-processed for use by the visual agent 208, the visual agent 208 may pre-process the obtained source project data.

Yet another possible type of information that may be included in an input prompt received from the planner agent 202 may include the set of response information generated by the QA agent 206. In some implementations, the visual agent 208 may receive the set of response information directly from the QA agent 206 instead of from the planner agent 202.

Input prompts received by the visual agent 208 may include various other types of information as well.

Some example input prompts that the visual agent 208 may receive from the planner agent 202 may include: “Overlay two drawings in the same scale and orientation to show a conflicted area, and circle the conflicted area with a red outline,” “Find photos taken in the conflicted area and show them in a sequence based on time in a side-by-side view to the overlaid drawings,” and “Provide a 200-word-or-less script based on the set of response information that explains the situation with the conflicted area, and that includes instructions for when to show (i) the overlaid drawings with the circled conflicted area and (ii) the sequenced images based on the script.” As may be appreciated, the visual agent 208 may receive various other input prompts, e.g., depending on the request for media content.

The visual agent's functionality may take any of various forms. Firstly, the visual agent's functionality may include receiving one or more input prompts from the planner agent 202, as described above.

The visual agent's functionality may also include completing tasks based on instructions included in the one or more input prompts received from the planner agent 202. This functionality may take various forms, depending on the one or more input prompts received from the planner agent 202.

In line with the above discussion, one task that the visual agent 208 may complete may be to generate visual features and a corresponding script for use in generating requested media content. To complete this task, the visual agent 208 may first determine which visual features to generate based on an analysis of (i) the set of project data, (ii) the determined industry best practices, (iii) the set of response information, and/or (iv) other information included in input prompts received from the planner agent 202. In line with the discussion above, the visual agent 208 may utilize the instance of the generative AI model accessible to the visual agent 208 to determine which visual features to generate. For instance, the visual agent 208 may provide input to the instance of the generative AI model, such as the visual agent's system prompt, the instructions to generate visual features for use in generating requested media content, the obtained set of project data, the determined industry best practices, and/or the obtained set of response information, among other possible inputs. The visual agent 208 may then obtain, from the instance of the generative AI model, an output indicating which visual features to generate. The visual agent 208 may determine which visual features to generate in other ways as well.

To generate the visual features, the visual agent 208 may either create new, generative visual features (e.g., such as an animation of a character, generative images, etc.), or the visual agent 208 may generate visual features based off of image or video data included in the set of project data. Further, in line with the previous discussion, the visual agent 208 may annotate one or more of the visual features, e.g., based on instructions included in one or more input prompts sent from the planner agent 202 and/or possibly based on the set of response information generated by the QA agent 206, among other things. In some implementations, the visual agent 208 may generate the visual features using capabilities of the visual agent 208 itself and/or by using capabilities of the instance of the generative AI model accessible to the visual agent 208. The visual agent 208 may generate the visual features in other ways as well.

After generating the visual features, the visual agent 208 may then generate a script corresponding to the generated visual features, e.g., based on instructions included in one or more input prompts sent from the planner agent 202 and/or possibly based on the set of response information generated by the QA agent 206. In some implementations, the visual agent 208 may utilize the instance of the generative AI model accessible to the visual agent 208 to generate the script. The visual agent 208 may generate the script in other ways as well.

In line with the above discussion, another task that the visual agent 208 may complete may be to provide the visual features and corresponding script to one or more of the agents of the software pipeline 200. To complete this task, the visual agent 208 may first determine which agent(s) to provide the visual features and corresponding script to. For instance, the visual agent 208 may provide input to the instance of the generative AI model accessible to the visual agent 208 (e.g., such as the inputs described above), and receive, as output from the generative AI model, an indication of which agent(s) the visual features and corresponding script is to be provided to. In line with the discussion above, this may include (i) an indication that the visual features and corresponding script are to be provided to the planner agent 202 for distribution to other agents of the software pipeline 200, and/or (ii) an indication that the visual features and corresponding script are to be provided directly to the other agents of the software pipeline 200.

The visual agent 208 may complete other tasks as well, and the functionality that the visual agent 208 may perform may take other forms as well.

Turning now to the speech agent 210, at a high level, the speech agent 210 may generally function to generate audio features for use in generating requested media content.

In line with the discussion above, the speech agent 210 may include a system prompt, which may include various types of information. One possible type of information that may be included in the system prompt for the speech agent 210 may include a description of the speech agent's role within the software pipeline 200, which may be to generate audio features for use in generating requested media content. Another possible type of information that may be included in the system prompt for the speech agent 210 may include a description of what information the speech agent 210 has access to, such as the visual features and corresponding script generated by the visual agent 208. One example system prompt for the speech agent 210 may be as follows: “You are a text to speech agent who can take a script, read the message included in the script out loud, and record the audio in high quality MP3 format.” Various other examples may also exist.

The system prompt for the speech agent 210 may include various other types of information as well.

In line with the previous discussion, the speech agent 210 may be configured to receive one or more input prompts from the planner agent 202, which may include various types of information.

One possible type of information that may be included in an input prompt received from the planner agent 202 may comprise instructions to complete one or more tasks, such as (i) instructions to generate audio features for use in generating requested media content, and/or (ii) instructions to provide the generated audio features to one or more agents of the software pipeline 200, among other possible tasks. The instructions to generate audio features for use in generating requested media content may specify what types of audio features to generate, such as (i) text-to-speech renditions of the message included in the script generated by the visual agent 208, (ii) text-to-speech renditions of textual elements of visual features generated by the visual agent 208 (text in a document, image, side, or video, etc.), and/or (iii) other audio (e.g., music, sound effects, etc.) for use in generating requested media content, among other types of audio features.

The instructions to generate audio features for use in generating requested media content may also specify what language the audio features are to be in, what accents to use for the audio features, and the like, e.g., based on an intended audience of the requested media content.

Another possible type of information that may be included in an input prompt received from the planner agent 202 may comprise the visual features and corresponding script generated by the visual agent 208. In some implementations, the speech agent 210 may receive the visual features and corresponding script directly from the visual agent 208 instead of from the planner agent 202.

Input prompts received by the speech agent 210 may include various other types of information as well.

An example input prompt that the speech agent 210 may receive from the planner agent 202 may include: “Generate, in English, an audio file reading of the message included in the script.” As may be appreciated, the speech agent 210 may receive various other input prompts, e.g., depending on the request for media content.

The speech agent's functionality may take any of various forms. Firstly, the speech agent's functionality may include receiving one or more input prompts from the planner agent 202, as described above.

The speech agent's functionality may also include completing tasks based on instructions included in the one or more input prompts received from the planner agent 202. This functionality may take various forms, depending on the one or more input prompts received from the planner agent 202.

In line with the above discussion, one task that the speech agent 210 may complete may be to generate audio features for use in generating requested media content. To complete this task, the speech agent 210 may first determine which audio features to generate based on an analysis of (i) the script generated by the visual agent 208, (ii) the visual features generated by the visual agent 208, and/or (iii) other information included in input prompts received from the planner agent 202. In line with the discussion above, the speech agent 210 may utilize the instance of the generative AI model accessible to the speech agent 210 to determine which audio features to generate. For instance, the speech agent 210 may provide input to the instance of the generative AI model, such as the speech agent's system prompt, the instructions to generate audio features for use in generating requested media content, the script generated by the visual agent 208, and/or the visual features generated by the visual agent, among other possible inputs. The speech agent 210 may then obtain, from the instance of the generative AI model, an output indicating which audio features to generate. The speech agent 210 may determine which audio features to generate in other ways as well.

The speech agent 210 may then generate the determined audio features, which may include (i) a text-to-speech rendition of some or all of the script generated by the visual agent 208 (which may be in a given language or with a given accent, based on instructions included in one or more input prompts from the planner agent 202), (ii) a text-to-speech rendition of textual elements of the visual features generated by the visual agent 208 (e.g., textual elements on a slide, document, image, video, etc.), and/or (iii) other audio features (e.g., music, sound effects, etc.) for use in generating the requested media content. In line with the discussion above, the speech agent 210 may utilize the instance of the generative AI model accessible to the speech agent 210 to generate audio features for use in generating requested media content. For instance, the speech agent 210 may provide input to the instance of the generative AI model, such as the speech agent's system prompt, the instructions to generate audio features for use in generating requested media content, the visual features generated by the visual agent 208, and/or and the script generated by the visual agent 208, among other possible inputs. The speech agent 210 may then obtain, from the instance of the generative AI model, an output comprising the audio features. The speech agent 210 may generate the audio features in other ways as well.

In line with the above discussion, another task that the speech agent 210 may complete may be to provide the audio features to one or more of the agents of the software pipeline 200. To complete this task, the speech agent 210 may first determine which agent(s) to provide the audio features to. For instance, the speech agent 210 may provide input to the instance of the generative AI model accessible to the speech agent 210 (e.g., such as the inputs described above), and receive, as output from the instance of the generative AI model, an indication of which agent(s) the audio features are to be provided to. In line with the discussion above, this may include (i) an indication that the audio features are to be provided to the planner agent 202 for distribution to other agents of the software pipeline 200, and/or (ii) an indication that the audio features are to be provided directly to the other agents of the software pipeline 200.

The speech agent 210 may complete other tasks as well, and the functionality that the speech agent 210 may perform may take other forms as well.

Turning now to the production agent 212, at a high level, the production agent 212 may generally function to generate the requested media content.

In line with the discussion above, the production agent 212 may include a system prompt, which may include various types of information. One possible type of information that may be included in the system prompt for the production agent 212 may include a description of the production agent's role within the software pipeline 200, which may be to generate requested media content. Another possible type of information that may be included in the system prompt for the production agent 212 may include a description of what information the production agent 212 has access to, such as the visual features and corresponding script generated by the visual agent 208 and the audio features generated by the speech agent 210, among other examples. One example system prompt for the production agent 212 may be as follows: “You are an experienced video production professional who can select the right features to include in media content, introduce fade-in, fade-out, pan, and zoom features to tell a story, together with a provided audio track. Remember to provide a branded introduction and conclusion at the end of the requested media content.” Various other examples may also exist.

The system prompt for the production agent 212 may include various other types of information as well.

In line with the previous discussion, the production agent 212 may be configured to receive one or more input prompts from the planner agent 202, which may include various types of information.

One possible type of information that may be included in an input prompt received from the planner agent 202 may comprise instructions to complete a task, such as instructions to generate requested media content, among other possible tasks.

Another possible type of information that may be included in an input prompt received from the planner agent 202 may comprise the visual features and corresponding script generated by the visual agent 208. In some implementations, the production agent 212 may receive the visual features and corresponding script directly from the visual agent 208 instead of from the planner agent 202.

Another possible type of information that may be included in an input prompt received from the planner agent 202 may comprise the audio features generated by the speech agent 210. In some implementations, the production agent 212 may receive the audio features directly from the speech agent 210 instead of from the planner agent 202.

Input prompts received by the production agent 212 may include various other types of information as well.

An example input prompt for the production agent 212 may be “Combine the visual features mentioned in the video script together with the audio files generated by the speech agent to produce a 2-minute video in MP4 format.” As may be appreciated, the production agent 212 may receive various other input prompts, e.g., depending on the request for media content.

The production agent's functionality may take any of various forms. Firstly, the production agent's functionality may include receiving one or more input prompts from the planner agent 202, as described above.

The production agent's functionality may also include completing tasks based on instructions included in the one or more input prompts received from the planner agent 202. This functionality may take various forms, depending on the one or more input prompts received from the planner agent 202.

In line with the above discussion, one task that the production agent 212 may complete may be to generate requested media content. The production agent 212 may generate the requested media content based on (i) the visual features and corresponding script generated by the visual agent 208 and/or (ii) the audio features generated by the speech agent 210, among other things. For instance, the production agent 212 may generate a video that includes (i) the visual features generated by the visual agent 208 at certain times in the video, according to instructions included in the script, and (ii) the audio features generated by the speech agent 210. In line with the discussion above, the production agent 212 may utilize the instance of the generative AI model accessible to the production agent 212 to generate the requested media content. For instance, the production agent 212 may provide input to the instance of the generative AI model, such as the production agent's system prompt, the instructions to generate requested media content, the visual features generated by the visual agent 208, the script generated by the visual agent 208, and/or the audio features generated by the speech agent 210, among other possible inputs. The production agent 212 may then obtain, from the instance of the generative AI model, an output comprising the requested media content. The production agent 212 may generate the requested media content in other ways as well.

The production agent 212 may complete other tasks as well, and the functionality that the production agent 212 may perform may take other forms as well.

Turning now to the quality control agent 214, at a high level, the quality control agent 214 may generally function to validate the outputs of the other agents of the software pipeline 200.

In line with the discussion above, the quality control agent 214 may include a system prompt, which may include various types of information. One possible type of information that may be included in the system prompt for the quality control agent 214 may include a description of the quality control agent's role within the software pipeline 200, which may be to validate the outputs of the other agents of the software pipeline 200.

Another possible type of information that may be included in the system prompt for the quality control agent 214 may include a description of the other agents in the software pipeline 200. This may include information describing the respective role of each of the other agents, whether any dependencies exist between the other agents (e.g., whether one agents' output is a required input of another agent, etc.), and/or the respective format that each of the other agents is configured to receive input prompts in, among other possibilities. As described in greater detail below, the description of the other agents in the software pipeline 200 may be included in an input prompt received from the planner agent 202 instead of being included in the system prompt of the quality control agent 214.

Yet another possible type of information that may be included in the system prompt for the quality control agent 214 may include a description of any rules that are defined for how the quality control agent 214 should validate the output(s) of the other agents in the software pipeline 200, which may include (i) one or more rules that define the expected format and standards the output(s) of one or more of the other agents in the software pipeline 200, including the expected format and standards for the generated media content itself (e.g., as output by the production agent 212).

One example system prompt for the quality control agent 214 may be as follows: “You are a quality control agent responsible for reviewing the outputs of each agent to ensure that they meet the expected format and standards. Additionally, you must verify that the final result of the software pipeline aligns with the user's original request.” Another example system prompt for the quality control agent 214 may be as follows: “You are a quality control agent for a video generating system for construction projects. Below is the content generated. Please follow the guidelines below and create a score between 1 and 10: 1) The generated content should be accurate, based on the project documents provided. 2) The generated content should not have any profanity. 3) The generated content should be in a gender-neutral language. Avoid usage of words like he, him, she her. Instead, use third person terms like it, they, etc. 4) Assess whether the language is very strong in the content generated. The objective is to create a summary of the documents, without being partial or adding self-thoughts/recommendations to it.” Various other examples may also exist.

The system prompt for the quality control agent 214 may include various other types of information as well.

In line with the previous discussion, the quality control agent 214 may be configured to receive one or more input prompts from the planner agent 202, which may include various types of information.

One possible type of information that may be included in an input prompt received from the planner agent 202 may include instructions to complete a task, such as instructions to validate the outputs of the other agents of the software pipeline 200, among other possible tasks.

Another possible type of information that may be included in an input prompt received from the planner agent 202 may comprise a description of the other agents in the software pipeline 200, e.g., in implementations where the description of the other agents in the software pipeline 200 is not included in the system prompt of the quality control agent 214.

Input prompts received by the quality control agent 214 may include various other types of information as well.

An example input prompt that the quality control agent 214 may receive from the planner agent 202 may include: “Validate the outputs of the other agents of the software pipeline. Outputs of the knowledge agent 204 should take the form of Json objects, and the script generated by the visual agent 208 should have no more than 200 words.” As may be appreciated, the quality control agent 214 may receive various other input prompts as well.

The quality control agent's functionality may take any of various forms. Firstly, the quality control agent's functionality may include receiving one or more input prompts from the planner agent 202, as described above.

The quality control agent's functionality may also include completing tasks based on instructions included in the one or more input prompts received from the planner agent 202. This functionality may take various forms, depending on the one or more input prompts received from the planner agent 202.

In line with the above discussion, one task that the quality control agent 214 may complete may be to validate the outputs of the other agents of the software pipeline 200. To complete this task, the quality control agent 214 may communicate with each of the agents of the software pipeline 200 and instruct the agent to perform various tasks. As one example, the quality control agent 214 may instruct the agent to double check the agent's output(s), such as by asking the agent to confirm that outputs are helpful to the tasks being performed, asking the agent to confirm that the output is in compliance with a set of rules that may be defined for the output (e.g., a rule requiring that video media content is no longer than two minutes, a rule that the media content respects the metrics, languages, or other considerations of a geographical region for which the media content is being automatically generated, etc.), among other possible ways of instructing the agent to double check the agent's output(s). As another example, the quality control agent 214 may provide additional information or suggestions to the agent in order to improve the agent's output(s). As yet another example, the quality control agent 214 may instruct the agent to approach tasks assigned to the agent in a different way. Various other examples may also exist. By instructing each agent to perform these tasks, the quality control agent 214 may cause the outputs of the agents of the software pipeline 200 to be more accurate, comprehensive, and/or complete.

Further, in some implementations, the system prompts of the agents of the software pipeline 200 may include similar instructions, such that the agents of the software pipeline 200 may be configured to perform validation operations on their own outputs, in addition to or possible instead of the quality control agent's validation operations.

In line with the discussion above, the quality control agent 214 may utilize the instance of the generative AI model accessible to the quality control agent 214 to validate the outputs of the other agents of the software pipeline 200. For instance, the quality control agent 214 may provide input to the instance of the generative AI model, such as the quality control agent's system prompt, the instructions to validate the output of the other agents, the descriptions of the other agents in the software pipeline 200, and/or various outputs from the other agents in the software pipeline 200 that are to be validated, among other possible inputs. The quality control agent 214 may then obtain, from the instance of the generative AI model, an output comprising one or more input prompts that are to be transmitted to the other agents of the software pipeline 200 to validate outputs of the other agents. The quality control agent 214 may validate the outputs of the other agents of the software pipeline 200 in other ways as well.

In practice, the quality control agent 214 may validate the outputs of the agents 202-212 at various times and based on various trigger events. As one possibility, the quality control agent 214 may validate the outputs of the other agents of the software pipeline 200 as each agent performs its respective task(s). For instance, the quality control agent 214 may validate one or more outputs of the planner agent 202 that the planner agent 202 is to transmit as input prompts to other agents of the software pipeline 200, e.g., before the planner agent 202 transmits the input prompts to the other agents of the software pipeline 200. As another possibility, the quality control agent 214 may validate the output of a given agent of the software pipeline 200 and, based on determining that one or more issues exist in the output, validate outputs of one or more other agents of the software pipeline 200, e.g., agents that provided input prompts or other information to the given agent. This may enable the quality control agent 214 to identify a cause of the one or more issues in the output of the given agent, which may have originated from the output of a different agent of the software pipeline 200. Various other examples may also exist, and the quality control agent 214 may validate the outputs of the other agents of the software pipeline 200 at various other times and based on various other trigger events as well.

The quality control agent 214 may complete other tasks as well, and the functionality that the quality control agent 214 may perform may take other forms as well.

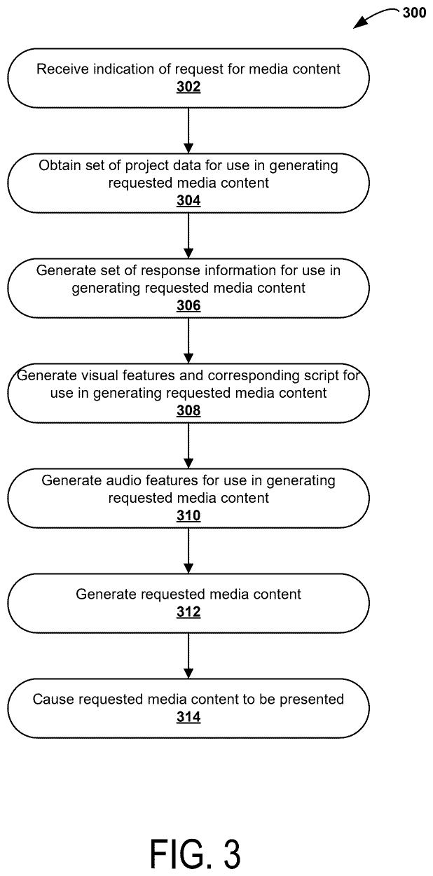

One possible example of functionality 300 that may be carried out to generate requested media content will now be described with reference to the flow chart of FIG. 3. In practice, the functionality 300 of FIG. 3 may be encoded in the form of program instructions that are executable by one or more processors of a computing platform, and for purposes of illustration, the functionality 300 of FIG. 3 is described as being carried out by the back-end computing platform 102 of FIG. 1, but it should be understood that the functionality 300 of FIG. 3 may be carried out by any one or more computing platforms that are capable of being installed with software for performing the functions described below. Further, it should be understood that the example functionality 300 of FIG. 3 is merely described in this manner for the sake of clarity and explanation and that the example functionality 300 may be implemented in various other manners, including the possibility that functions may be added, removed, rearranged into different orders, combined into fewer blocks, and/or separated into additional blocks depending upon the particular example.

At block 302, the back-end computing platform 102 may receive an indication of a request for media content that is input to a client device 104 that is operated by a user of the construction management software application. For instance, after receiving the indication of the request for media content, the client device 104 may transmit the indication of the request for media content to the back-end computing platform 102 via the communication path 106 between the client device 104 and the back-end computing platform 102. The indication of the request for media content may take various forms, as described above with respect to FIG. 2.

At block 304, the back-end computing platform 102 may obtain a set of project data for use in generating the requested media content. The set of project data may take any of various forms, as described above with respect to FIG. 2. Further, the functionality for obtaining the set of project data may take various forms, and may involve various of the agents of the software pipeline 200, as described above with respect to FIG. 2. For instance, the functionality for obtaining the set of project data may involve functionality of the planner agent 202, which may include (i) determining tasks that are to be completed by the knowledge agent 204 to obtain the set of project data and (ii) coordinating with the knowledge agent 204 to obtain the set of project data, among other functionality of the planner agent 202 described above with respect to FIG. 2. Further, the functionality for obtaining the set of project data may involve functionality of the knowledge agent 204, which may involve functionality for determining and obtaining the set of project data from source project data, among other functionality of the knowledge agent 204 described above with respect to FIG. 2. Further yet, although not shown, the back-end computing platform 102 may obtain an indication of industry best practices, which may be determined based on the set of source project in line with the discussion above. The functionality for obtaining the set of project data may take other forms as well.

At block 306, the back-end computing platform 102 may generate a set of response information for use in generating the requested media content. The set of response information may take any of various forms, as described above with respect to FIG. 2. Further, the functionality for generating the set of response information may take various forms and may involve various of the agents of the software pipeline 200, as described above with respect to FIG. 2. For instance, the functionality for generating the set of response information may involve functionality of the planner agent 202, which may include (i) determining tasks that are to be completed by the QA agent 206 to generate the set of response information and (ii) coordinating with the QA agent 206 to generate the set of response information, among other functionality of the planner agent 202 described above with respect to FIG. 2. Further, the functionality for generating the set of response information may involve functionality of the QA agent 206, which may include obtaining construction methodology information and sequencing information and generating the set of response information based on an analysis of (i) the construction methodologies and sequencing information, (ii) a question and/or request included in the request for media content, (iii) the set of project data, (iv) the determined industry best practices, and (v) any indication of the types of information to include in the set of response information that may be included in input prompts received from the planner agent 202, among other functionality of the QA agent 206 described above with respect to FIG. 2. The functionality for generating the set of response information may take other forms as well.

At block 308, the back-end computing platform 102 may generate visual features and a corresponding script for use in generating the requested media content. The visual features and corresponding script may take any of various forms, as described above with respect to FIG. 2. Further, the functionality for generating the visual features and corresponding script may take various forms and may involve various of the agents of the software pipeline 200, as described above with respect to FIG. 2. For instance, the functionality for generating the visual features and corresponding script may involve functionality of the planner agent 202, which may include (i) determining tasks that are to be completed by the visual agent 208 to generate the visual features and corresponding script and (ii) coordinating with the visual agent 208 to generate the visual features and corresponding script, among other functionality of the planner agent 202 described above with respect to FIG. 2. Further, the functionality for generating the visual features and corresponding script may involve functionality of the visual agent 208, which may include (i) determining which visual features to generate based on an analysis of the set of project data, the determined industry best practices, the set of response information, and/or other information included in input prompts received from the planner agent 202, (ii) generating the determined visual features, and (iii) generating the corresponding script, among other functionality of the visual agent 208 described above with respect to FIG. 2. The functionality for generating the visual features and corresponding script may take other forms as well.

At block 310, the back-end computing platform 102 may generate audio features for use in generating the requested media content. The audio features may take any of various forms, as described above with respect to FIG. 2. Further, the functionality for generating the audio features may take various forms and may involve various of the agents of the software pipeline 200, as described above with respect to FIG. 2. For instance, the functionality for generating the audio features may involve functionality of the planner agent 202, which may include (i) determining tasks that are to be completed by the speech agent 210 to generate the audio features and (ii) coordinating with the speech agent 210 to generate the audio features, among other functionality of the planner agent 202 described above with respect to FIG. 2. Further, the functionality for generating the audio features may involve functionality of the speech agent 210, which may include (i) determining which audio features to generate based on an analysis of the script generated by the visual agent 208, the visual features generated by the visual agent 208, and/or other information included in input prompts received from the planner agent 202, and then (ii) generating the determined audio features, among other functionality of the speech agent 210 described above with respect to FIG. 2. The functionality for generating the audio features may take other forms as well.

At block 312, the back-end computing platform 102 may generate the requested media content. The generated media content may take any of various forms, as described above with respect to FIG. 2. Further, the functionality for generating the requested media content may take various forms and may involve various of the agents of the software pipeline 200, as described above with respect to FIG. 2. For instance, the functionality for generating the requested media content may involve functionality of the planner agent 202, which may include (i) determining tasks that are to be completed by the production agent 212 to generate the requested media content and (ii) coordinating with the production agent 212 to generate the requested media content, among other functionality of the planner agent 202 described above with respect to FIG. 2. Further, the functionality for generating the requested media content may involve functionality of the production agent 212, which may include generating the requested media content based on (i) the visual features and corresponding script generated by the visual agent 208 and (ii) the audio features generated by the speech agent 210, among other functionality of the production agent 212 described above with respect to FIG. 2. The functionality for generating the requested media content may take other forms as well.

In line with the previous discussion, the back-end computing platform 102 may utilize the quality control agent 214 to validate the outputs of the other agents of the software pipeline 200, as described above with respect to FIG. 2.

At block 314, the back-end computing platform 102 may cause the requested media content to be presented, e.g., via the client device 104A operated by the user. To accomplish this, the back-end computing platform 102 may transmit the requested media content to the client device 104A (e.g., via the communication path 106), and the client device 104A may then present the requested media content, e.g., via one or more speakers, displays, etc. of the client device 104A.

Example implementations of how the software pipeline 200 may be used to generate media content based on user requests will now be described.

As a first example implementation, a user of a construction management software application may utilize the software pipeline 200 to (i) determine conflicts between pipe designs and duct work of a given construction project, and (ii) generate an RFI to address any determined conflicts. In this example implementation, the user may input, to the software pipeline 200, user input including (i) a request for the software pipeline 200 to determine any conflicts between pipe designs and duct work for a given construction project, (ii) project data for the given construction project, or, alternatively, instructions to obtain project data available to the software pipeline 200, and (iii) a request for the software pipeline 200 to generate an RFI to address any determined conflicts. This user input may be provided to the planner agent 202, and based on receiving the user input, the planner agent 202 may generate and provide a sequence of tasks to other agents of the software pipeline 200 to generate the requested RFI. For instance, the planner agent 202 may provide instructions to the knowledge agent 204 to obtain a set of project data relevant to the pipe designs and duct work for the given construction project, such as drawings, specifications, schedules, and/or daily logs, among other types of project data, and provide the set of project data to one or more of the agents of the software pipeline 200. The planner agent 202 may additionally provide instructions to the QA agent 206 to generate a set of response information that includes (i) a description of any conflicts between the pipe designs and duct work for the given construction project and (ii) one or more suggestions for avoiding said conflicts, among other possible types of information. The planner agent 202 may additionally provide instructions to the visual agent 208 to (i) generate visual features of the media content based on the set of response information, such as images, videos, drawings, slides etc. that highlight one or more areas where conflicts exist between the pipe designs and the duct work for the given construction project and (ii) generate a script corresponding to the generated visual features that includes instructions for how to include the generated visual features in the requested media content. The planner agent 202 may additionally provide instructions to the speech agent 210 to generate audio features for the media content, in line with the previous discussion. The planner agent 202 may additionally provide instructions to the production agent 212 to generate the media content, which in this example comprises an audio/visual presentation that shows any determined conflicts between the pipe designs and the duct work, as well as an RFI that addresses the determined conflicts. In line with the discussion above, the quality control agent 214 may validate outputs of the other agents of the software pipeline 200. After the requested media content has been generated (and validated), the back-end computing platform 102 may then cause the generated audio/visual presentation and RFI to be presented to the user. In some examples of this first example implementation, the back-end computing platform 102 may further cause the generated RFI to be automatically created within the construction management software application, in addition to or instead of being presented to the user.

As a second example implementation, a user may utilize the software pipeline 200 to (i) determine a weekly summary of key activities, progress, and/or issues in a given construction project and (ii) generate a short video highlighting the weekly summary, along with one or more suggestions to address any determined issues. In this example implementation, the user may provide input to the software pipeline 200 such as field photos, daily logs, meeting minutes, meeting transcripts, punch items, RFIs, submittal changes, statuses, etc., or otherwise cause the software pipeline 200 to access said information. The software pipeline 200 may then, utilizing the various agents 202-214 in line with the previous discussion, generate and provide to the user a short video highlighting the weekly summary, along with one or more suggestions to address any determined issues in the given construction project.

As a third example implementation, a user, such as a superintendent of a given construction project, may utilize the software pipeline 200 to (i) determine a progress of the key workfront of the given construction project and (ii) generate a short video highlighting the progress of the key workfront of the given construction project. In this example implementation, the user may provide one or more images to the software pipeline 200 as input, or otherwise cause the software pipeline 200 to access said images. The software pipeline 200 may then, utilizing the various AI agents 202-214 in line with the previous discussion, (i) pre-process the one or more images to prepare the one or more images for use by other agents of the software pipeline 200, (ii) generate a short video highlighting the progress of the key workfront of the given construction project based on the pre-processed images, and then (iii) cause the generated short video to be presented to the user. In this example, the knowledge agent 204 may be able to use the pre-processed images to obtain a set of project data that is contextualized to locations, dates, and areas of activity that are relevant to the progress of the key work from of the given construction project.

As a fourth example implementation, a user, e.g., the superintendent of a given construction project, may utilize the software pipeline 200 to (i) determine who is currently responsible for completing the next task for the given construction project, e.g., so that progress may continue for the given construction project, and (ii) generate media content identifying who is currently responsible for completing the next task. In this example implementation, the user may provide input to the software pipeline 200 such as schedules, daily logs, etc., or otherwise cause the software pipeline 200 to access said information. The software pipeline 200 may then, utilizing the agents of the software pipeline 200 in line with the previous discussion, generate and provide to the user the requested media content identifying who is currently responsible for completing the next task.

As a fifth example implementation, a user may utilize the software pipeline 200 to (i) analyze a number of bidding proposals for a scope of work and (ii) generate a short video showing a comparison of bids, together with a choice matrix for the bidding proposals. In this example implementation, the user may provide input to the software pipeline 200 such as details of the bidding proposals, or otherwise cause the software pipeline 200 to access said information. The software pipeline 200 may then, utilizing the agents of the software pipeline 200 in line with the previous discussion, generate and provide to the user the short video showing a comparison of the bids, together with a choice matrix for bidding proposals. The short video may show additional information as well, such as a preferred bidding proposal, along with reasons why the bidding proposal is preferred, among other information.

As a sixth example implementation, a user may utilize the software pipeline 200 to (i) generate a site survey mobilization video, showing all the site mobile photos, site measurements, and optionally drone footage that show how a given construction site is being prepared to begin construction. In this example implementation, the user may provide input to the software pipeline 200 such as field photos, schematics, drawings, BIM models, videos, etc., or otherwise cause the software pipeline 200 to access said information. The software pipeline 200 may then, utilizing the agents of the software pipeline 200 in line with the previous discussion, generate and provide to the user the requested site survey mobilization video.

As a seventh example implementation, a user may utilize the software pipeline 200 to (i) determine a progress review of a given construction project (e.g., a quarterly review) and (ii) generate a short video highlighting the progress review. In this example implementation, the user may provide input to the software pipeline 200 such as RFIs, schedules (e.g., schedule delays), submittals, etc., along with industry data such as industry averages for amounts of RFIs created and closed for construction projects, amounts of submittal created and closed for construction projects, etc., or otherwise cause the software pipeline 200 to access said information. The software pipeline 200 may then, utilizing the agents of the software pipeline 200 in line with the previous discussion, generate and provide to the user a short video highlighting the requested progress review, which may show how the progress of the given construction compares to industry averages, among other things.

As an eighth example implementation, a user may utilize the software pipeline 200 to (i) assist in utilizing construction management software and (ii) generate a short tutorial video or document highlighting areas of risk, such as scheduling risks (e.g., dues to tasks and/or activities being behind schedule), safety risks (e.g., due to observed site conditions), and/or budget risks (e.g., due to increased material price), among various other areas of risk. In this example implementation, the user may provide input to the software pipeline 200 such as a specific question, a hyperlink or other identifier for information on the construction management software, etc., or otherwise cause the software pipeline 200 to access said information. The software pipeline 200 may then, utilizing the agents of the software pipeline 200 in line with the previous discussion, generate and provide to the user a short video or document answering the user's question and highlighting areas of risk, among other things.

As a ninth example implementation, a user may utilize the software pipeline 200 to (i) determine a suggested course of action for completing a given task of a given construction project and (ii) generate a short video describing the suggested course of action. In this example implementation, the user may provide input to the software pipeline 200 such as a history of user interactions (e.g., interactions of the user or of other users who have completed similar tasks) for the given construction project (or other similar construction projects), among other project data for the given construction project or other similar construction projects, or otherwise cause the software pipeline 200 to access said information. The software pipeline 200 may then, utilizing the agents of the software pipeline 200 in line with the previous discussion, generate and provide to the user a short video describing the suggested course of action.

As a tenth example implementation, a user may utilize the software pipeline 200 to (i) determine a suggested course of action for completing a given task of a given construction project that is based on how other users of the software pipeline 200 have completed the given task in the past and (ii) generate a short video describing the suggested course of action. In this example implementation, the user may provide input to the software pipeline 200 such as a history of user interactions (e.g., of the user or of other users who have completed similar tasks in the past) for the given construction project or other similar projects, among other project data for the given construction project or other similar projects, or otherwise cause the software pipeline 200 to access said information. The software pipeline 200 may then, utilizing the agents of the software pipeline 200 in line with the previous discussion, generate and provide to the user a short video describing the suggested course of action. Further, in this example, the video may not disclose the identity of the other users of the software pipeline 200, so that they remain anonymous.

The example implementations described above are intended to show only some of the ways that the software pipeline 200 may be utilized to generate media content based on user requests, and it should be understood that various other examples may also exist.

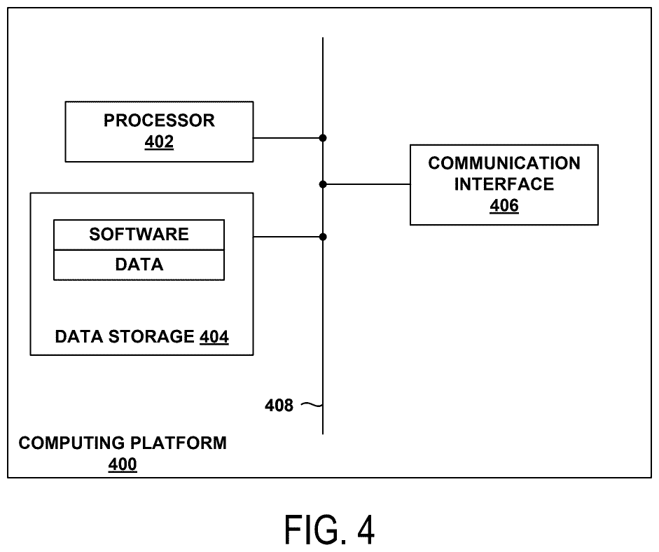

Turning now to FIG. 4, a simplified block diagram is provided to illustrate some structural components that may be included in an example computing platform 400 that may be configured to perform the server-side functions disclosed herein. At a high level, the example computing platform 400 may generally comprise any one or more computer systems (e.g., one or more servers) that collectively include one or more processors 402, data storage 404, and one or more communication interfaces 406, each of which may be communicatively linked by a communication link 408 that may take the form of a system bus, a communication network such as a public, private, or hybrid cloud, or some other connection mechanism. Each of these components may take various forms.

For instance, the one or more processors 402 may comprise one or more processor components, such as one or more central processing units (CPUs), graphics processing units (GPUs), application-specific integrated circuits (ASICs), digital signal processor (DSPs), and/or programmable logic devices such as field programmable gate arrays (FPGAs), among other possible types of processing components. In line with the discussion above, it should also be understood that the one or more processors 402 could comprise processing components that are distributed across a plurality of physical computing devices connected via a network, such as a computing cluster of a public, private, or hybrid cloud.

In turn, the data storage 404 may comprise one or more non-transitory computer-readable storage mediums, examples of which may include volatile storage mediums such as random-access memory, registers, cache, etc. and non-volatile storage mediums such as read-only memory, a hard-disk drive, a solid-state drive, flash memory, an optical-storage device, etc. In line with the discussion above, it should also be understood that the data storage 404 may comprise computer-readable storage mediums that are distributed across a plurality of physical computing devices connected via a network, such as a storage cluster of a public, private, or hybrid cloud that operates according to technologies such as AWS for Elastic Compute Cloud, Simple Storage Service, etc.

As shown in FIG. 4, the data storage 404 may be capable of storing both (i) program instructions that are executable by the one or more processors 402 such that the example computing platform 400 is configured to perform any of the various functions disclosed herein (including but not limited to any of the server-side functions discussed above), and (ii) data that may be received, derived, or otherwise stored by the example computing platform 400.

The one or more communication interfaces 406 may comprise one or more interfaces that facilitate communication between the example computing platform 400 and other systems or devices, where each such interface may be wired and/or wireless and may communicate according to any of various communication protocols. As examples, the one or more communication interfaces 406 may take include an Ethernet interface, a serial bus interface (e.g., Firewire, USB 4.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

Although not shown, the example computing platform 400 may additionally have an Input/Output (I/O) interface that includes or provides connectivity to I/O components that facilitate user interaction with the example computing platform 400, such as a keyboard, a mouse, a trackpad, a display screen, a touch-sensitive interface, a stylus, a virtual-reality headset, and/or one or more speaker components, among other possibilities.

It should be understood that the example computing platform 400 is one example of a computing platform that may be used with the examples described herein. Numerous other arrangements are possible and contemplated herein. For instance, in other examples, the example computing platform 400 may include additional components not pictured and/or more or less of the pictured components.

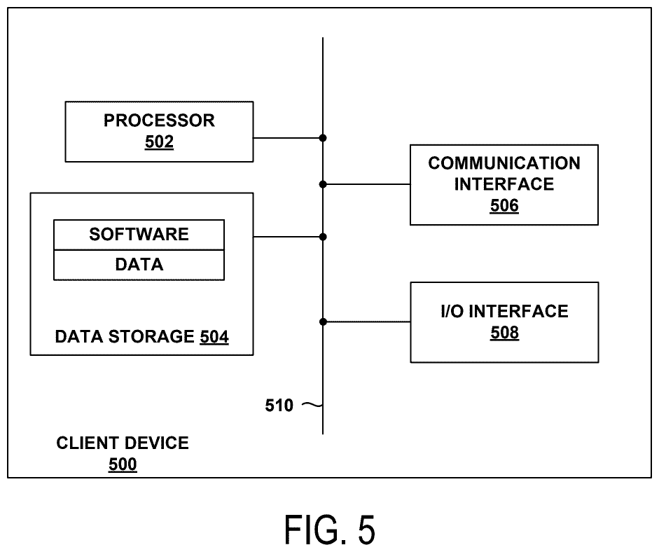

Turning next to FIG. 5, a simplified block diagram is provided to illustrate some structural components that may be included in an example client device 500 that may be configured to perform some the client-side functions disclosed herein. At a high level, the example client device 500 may include one or more processors 502, data storage 504, one or more communication interfaces 506, and an I/O interface 508, each of which may be communicatively linked by a communication link 510 that may take the form a system bus and/or some other connection mechanism. Each of these components may take various forms.

For instance, the one or more processors 502 of the example client device 500 may comprise one or more processor components, such as one or more CPUs, GPUs, ASICs, DSPs, and/or programmable logic devices such as FPGAs, among other possible types of processing components.

In turn, the data storage 504 of the example client device 500 may comprise one or more non-transitory computer-readable mediums, examples of which may include volatile storage mediums such as random-access memory, registers, cache, etc. and non-volatile storage mediums such as read-only memory, a hard-disk drive, a solid-state drive, flash memory, an optical-storage device, etc. As shown in FIG. 5, the data storage 504 may be capable of storing both (i) program instructions that are executable by the one or more processors 502 of the example client device 500 such that the example client device 500 is configured to perform any of the various functions disclosed herein (including but not limited to any of the client-side functions discussed above), and (ii) data that may be received, derived, or otherwise stored by the example client device 500.

The one or more communication interfaces 506 may comprise one or more interfaces that facilitate communication between the example client device 500 and other systems or devices, where each such interface may be wired and/or wireless and may communicate according to any of various communication protocols. As examples, the one or more communication interfaces 506 may take include an Ethernet interface, a serial bus interface (e.g., Firewire, USB 3.0, etc.), a chipset and antenna adapted to facilitate any of various types of wireless communication (e.g., Wi-Fi communication, cellular communication, Bluetooth® communication, etc.), and/or any other interface that provides for wireless or wired communication. Other configurations are possible as well.

The I/O interface 508 may generally take the form of (i) one or more input interfaces that are configured to receive and/or capture information at the example client device 500 and (ii) one or more output interfaces that are configured to output information from the example client device 500 (e.g., for presentation to a user). In this respect, the one or more input interfaces of I/O interface may include or provide connectivity to input components such as a microphone, a camera, a keyboard, a mouse, a trackpad, a touchscreen, and/or a stylus, among other possibilities, and the one or more output interfaces of the I/O interface 508 may include or provide connectivity to output components such as a display screen and/or an audio speaker, among other possibilities.

It should be understood that the example client device 500 is one example of a client device that may be used with the examples described herein. Numerous other arrangements are possible and contemplated herein. For instance, in other examples, the example client device 500 may include additional components not pictured and/or more or fewer of the pictured components.

### CONCLUSION

Example embodiments of the disclosed innovations have been described above. Those skilled in the art will understand, however, that changes and modifications may be made to the embodiments described without departing from the true scope and spirit of the present invention, which will be defined by the claims.

Further, to the extent that examples described herein involve operations performed or initiated by actors, such as “humans,” “operators,” “users,” or other entities, this is for purposes of example and explanation only. The claims should not be construed as requiring action by such actors unless explicitly recited in the claim language.

What is claimed is:

1. A computing platform comprising:
at least one processor;
at least one non-transitory computer-readable medium; and
program instructions stored on the at least one non-transitory computer-readable medium that, when executed by the at least one processor, cause the computing platform to:
receive an indication of a request for media content related to a given construction project;
utilize a planner agent to generate a sequence of tasks to be performed by other agents to generate the requested media content;
utilize a knowledge agent to perform a first subset of the sequence of tasks to obtain a set of project data for use in generating the requested media content;
utilize a production agent to perform a second subset of the sequence of tasks to generate the requested media content; and
cause the generated media content to be presented via a client device.

2. The computing platform of claim 1, further comprising program instructions stored on the at least one non-transitory computer-readable medium that, when executed by the at least one processor, cause the computing platform to:
utilize a question answering (QA) agent to perform a third subset of the sequence of tasks to generate, for use in generating the requested media content, a set of response information based on the set of project data;
utilize a visual agent to perform a fourth subset of the sequence of tasks to generate, for use in generating the requested media content, visual features and a corresponding script based on the set of response information; and
utilize a speech agent to perform a fifth subset of the sequence of tasks to generate, for use in generating the requested media content, audio features based on the visual features and the corresponding script;
wherein the program instructions that, when executed by the at least one processor, cause the computing platform to utilize the production agent to generate the requested media content comprise program instructions that, when executed by the at least one processor, cause the computing platform to utilize the production agent to generate the requested media content based on (i) the visual features and the corresponding script and (ii) the audio features.

3. The computing platform of claim 2, wherein the program instructions that, when executed by the at least one processor, cause the computing platform to utilize the QA agent to generate the set of response information comprise program instructions that, when executed by the at least one processor, cause the computing platform to utilize the QA agent to:
perform an analysis of the set of project data; and
generate the set of response information based on the analysis of the set of project data, wherein the set of response information includes at least one of (i) an answer to a question included in the request for media content, (ii) an identification of an issue identified for the given construction project, (iii) an identification of a proposed solution to an issue identified for the given construction project, or (iv) a status of the given construction project.

4. The computing platform of claim 2, wherein the program instructions that, when executed by the at least one processor, cause the computing platform to utilize the visual agent to generate the visual features and corresponding script comprise program instructions that, when executed by the at least one processor, cause the computing platform to utilize the visual agent to:
perform an analysis of at least one of (i) the set of project data or (ii) the set of response information; and
generate the visual features and the corresponding script based on the analysis of the at least one of (i) the set of project data or (ii) the set of response information, wherein the visual features include at least one of a video, an image, a document, or a slide, and wherein the corresponding script includes a message to be narrated within the requested media content.

5. The computing platform of claim 2, wherein the program instructions that, when executed by the at least one processor, cause the computing platform to utilize the speech agent to generate the audio features comprise program instructions that, when executed by the at least one processor, cause the computing platform to utilize the speech agent to:
perform an analysis of at least one of (i) the visual features or (ii) the corresponding script; and
generate the audio features based on the analysis of the at least one of (i) the visual features or (ii) the corresponding script, wherein the audio features include at least one of a text-to-speech rendition of a message included in the corresponding script, a text-to-speech rendition of one or more textual elements of the visual features, or sound effects corresponding to the visual features.

6. The computing platform of claim 2, further comprising program instructions stored on the at least one non-transitory computer-readable medium that, when executed by the at least one processor, cause the computing platform to:
utilize a quality control agent to validate at least one of (i) the sequence of tasks generated by the planner agent, (ii) the set of project data obtained by the knowledge agent, (iii) the set of response information generated by the QA agent, (iv) the visual features generated by the visual agent, (v) the corresponding script generated by the visual agent, or (vi) the audio features generated by the speech agent.

7. The computing platform of claim 2, wherein:
the planner agent is configured to utilize a respective instance of a generative AI model to generate the sequence of tasks;
the knowledge agent is configured to utilize a respective instance of a generative AI model to obtain the set of project data;
the QA agent is configured to utilize a respective instance of a generative AI model to generate the set of response information;
the visual agent is configured to utilize a respective instance of a generative AI model to generate the visual features and the corresponding script;
the speech agent is configured to utilize a respective instance of a generative AI model to generate the audio features; and
the production agent is configured to utilize a respective instance of a generative AI model to generate the requested media content.

8. The computing platform of claim 2, wherein each agent of the planner agent, the knowledge agent, the QA agent, the visual agent, the speech agent, and the production agent comprises a respective system prompt that defines functionality of the agent.

9. The computing platform of claim 1, wherein the program instructions that, when executed by the at least one processor, cause the computing platform to utilize the knowledge agent to obtain the set of project data comprise program instructions that, when executed by the at least one processor, cause the computing platform to utilize the knowledge agent to analyze source project data stored for one or more construction projects to determine the set of project data.

10. The computing platform of claim 9, wherein the source project data is stored as a knowledge graph having nodes and edges.

11. The computing platform of claim 1, wherein the generated media content comprises a generative video with corresponding generative audio that are each generated based on the obtained project data.

12. A non-transitory computer-readable medium, wherein the non-transitory computer-readable medium is provisioned with program instructions that, when executed by at least one processor, cause a computing platform to:
receive an indication of a request for media content related to a given construction project;
utilize a planner agent to generate a sequence of tasks to be performed by other agents to generate the requested media content;
utilize a knowledge agent to perform a first subset of the sequence of tasks to obtain a set of project data for use in generating the requested media content;
utilize a production agent to perform a second subset of the sequence of tasks to generate the requested media content; and
cause the generated media content to be presented via a client device.

13. The non-transitory computer-readable medium of claim 12, wherein the non-transitory computer-readable medium is further provisioned with program instructions that, when executed by at least one processor, cause the computing platform to:
utilize a question answering (QA) agent to perform a third subset of the sequence of tasks to generate, for use in generating the requested media content, a set of response information based on the set of project data;
utilize a visual agent to perform a fourth subset of the sequence of tasks to generate, for use in generating the requested media content, visual features and a corresponding script based on the set of response information; and
utilize a speech agent to perform a fifth subset of the sequence of tasks to generate, for use in generating the requested media content, audio features based on the visual features and the corresponding script;
wherein the program instructions that, when executed by at least one processor, cause the computing platform to utilize the production agent to generate the requested media content comprise program instructions that, when executed by at least one processor, cause the computing platform to utilize the production agent to generate the requested media content based on (i) the visual features and the corresponding script and (ii) the audio features.

14. The non-transitory computer-readable medium of claim 13, wherein the program instructions that, when executed by at least one processor, cause the computing platform to utilize the QA agent to generate the set of response information comprise program instructions that, when executed by at least one processor, cause the computing platform to utilize the QA agent to:
perform an analysis of the set of project data; and
generate the set of response information based on the analysis of the set of project data, wherein the set of response information includes at least one of (i) an answer to a question included in the request for media content, (ii) an identification of an issue identified for the given construction project, (iii) an identification of a proposed solution to an issue identified for the given construction project, or (iv) a status of the given construction project.

15. The non-transitory computer-readable medium of claim 13, wherein the program instructions that, when executed by at least one processor, cause the computing platform to utilize the visual agent to generate the visual features and corresponding script comprise program instructions that, when executed by at least one processor, cause the computing platform to utilize the visual agent to:
perform an analysis of at least one of (i) the set of project data or (ii) the set of response information; and
generate the visual features and the corresponding script based on the analysis of the at least one of (i) the set of project data or (ii) the set of response information, wherein the visual features include at least one of a video, an image, a document, or a slide, and wherein the corresponding script includes a message to be narrated within the requested media content.

16. The non-transitory computer-readable medium of claim 13, wherein the program instructions that, when executed by at least one processor, cause the computing platform to utilize the speech agent to generate the audio features comprise program instructions that, when executed by at least one processor, cause the computing platform to utilize the speech agent to:
perform an analysis of at least one of (i) the visual features or (ii) the corresponding script; and
generate the audio features based on the analysis of the at least one of (i) the visual features or (ii) the corresponding script, wherein the audio features include at least one of a text-to-speech rendition of a message included in the corresponding script, a text-to-speech rendition of one or more textual elements of the visual features, or sound effects corresponding to the visual features.

17. The non-transitory computer-readable medium of claim 13, wherein the non-transitory computer-readable medium is further provisioned with program instructions stored that, when executed by at least one processor, cause the computing platform to:
utilize a quality control agent to validate at least one of (i) the sequence of tasks generated by the planner agent, (ii) the set of project data obtained by the knowledge agent, (iii) the set of response information generated by the QA agent, (iv) the visual features generated by the visual agent, (v) the corresponding script generated by the visual agent, or (vi) the audio features generated by the speech agent.

18. The non-transitory computer-readable medium of claim 13, wherein:
the planner agent is configured to utilize a respective instance of a generative AI model to generate the sequence of tasks;
the knowledge agent is configured to utilize a respective instance of a generative AI model to obtain the set of project data;
the QA agent is configured to utilize a respective instance of a generative AI model to generate the set of response information;
the visual agent is configured to utilize a respective instance of a generative AI model to generate the visual features and the corresponding script;
the speech agent is configured to utilize a respective instance of a generative AI model to generate the audio features; and
the production agent is configured to utilize a respective instance of a generative AI model to generate the requested media content.

19. The non-transitory computer-readable medium of claim 13, wherein each agent of the planner agent, the knowledge agent, the QA agent, the visual agent, the speech agent, and the production agent comprises a respective system prompt that defines functionality of the agent.

20. A method implemented by a computing platform, the method comprising:
receiving an indication of a request for media content related to a given construction project;
utilizing a planner agent to generate a sequence of tasks to be performed by other agents to generate the requested media content;
utilizing a knowledge agent to perform a first subset of the sequence of tasks to obtain a set of project data for use in generating the requested media content;
utilizing a production agent to perform a second subset of the sequence of tasks to generate the requested media content; and
causing the generated media content to be presented via a client device.
